(19) United States
(12) Patent Application Publication
(10) Pub. No.: US 2025/0069112 A1
(43) Pub. Date: Feb. 27, 2025

(54) ELECTRONIC APPARATUS FOR PROVIDING ADVERTISEMENT AND CONTROL METHOD THEREFOR

(71) Applicant: SAMSUNG ELECTRONICS CO., LTD., Suwon-si (KR)

(72) Inventors: Hyunwoo CHUN, Suwon-si (KR); Wonkyun KIM, Suwon-si (KR); Sanghun PARK, Suwon-si (KR); Hyesu YEOM, Suwon-si (KR); Seongmin JOE, Suwon-si (KR)

(73) Assignee: SAMSUNG ELECTRONICS CO., LTD., Suwon-si (KR)

(21) Appl. No.: 18/941,951

(22) Filed: Nov. 8, 2024

Related U.S. Application Data
(63) Continuation of application No. PCT/KR2023/006417, filed on May 11, 2023.

(30) Foreign Application Priority Data
Jul. 7, 2022 (KR) 10-2022-0084035

(51) Int. Cl. G06Q 30/0242; G06Q 30/0251

(52) U.S. Cl. CPC G06Q 30/0245; G06Q 30/0243; G06Q 30/0256; G06Q 30/0269

(57) ABSTRACT

An electronic apparatus comprises: a display; a memory that stores a trained first artificial intelligence model; and at least one processor that acquires viewing group information of a user by inputting context information including profile information of the user and use history information of the electronic apparatus into the first artificial intelligence model, controls the display to display advertisement content identified on a basis of the obtained viewing group information, acquires feedback information of the user related to the displayed advertisement content, and updates the first artificial intelligence model to a second artificial intelligence model retrained on the basis of the input context information and the obtained feedback information.

### CROSS REFERENCE TO THE RELATED APPLICATIONS

This application is a continuation application, filed under 35 U.S.C. § 111(a), of International Application PCT/KR2023/006417 filed May 11, 2023 and is based on and claims priority under 35 U.S.C. § 119 to Korean Patent Applications No. 10-2022-0084035, filed on Jul. 7, 2022, in the Korean Intellectual Property Office, the disclosures of which are incorporated by reference herein in their entireties.

### BACKGROUND OF THE INVENTION

### Field of the Invention

The disclosure relates to an electronic apparatus and a control method thereof, and more particularly, to an electronic apparatus that provides an advertisement content appropriate for a user, and a control method thereof.

### Description of the Related Art

For specifying a user terminal apparatus appropriate for an advertisement content, a similar group may be extracted based on data obtained in a user terminal apparatus. The extracted similar group may be used in an advertisement targeting operation for providing an appropriate advertisement to a user terminal apparatus.

Here, in extracting a similar group, an artificial intelligence model may be used. An artificial intelligence model may output a similar group and a probability value corresponding to the similar group by using data obtained in a user terminal apparatus as input data.

As an artificial intelligence model once designated is not updated in real time, the extracted similar group in case the same data is input may also be the same. In case an appropriate advertisement is provided to a user, the appropriate advertisement will be repetitively provided through the artificial intelligence model later. However, in case an advertisement that is not appropriate for a user is provided, there is a high possibility that an advertisement not desired by the user is repetitively provided later.

### DETAILED DESCRIPTION OF THE INVENTION

### Technical Solution

The disclosure was devised for improving the aforementioned problem, and the purpose of the disclosure is in providing an electronic apparatus that updates an artificial intelligence model used in obtaining information on a viewing group representing a user in consideration of context information of the user and feedback information of the user, and a control method thereof.

An electronic apparatus according to an embodiment of the disclosure for achieving the aforementioned purpose includes a display, a memory storing a trained first artificial intelligence model, and at least one processor configured to obtain viewing group information of a user by inputting context information including profile information of the user and use history information of the electronic apparatus into the first artificial intelligence model, control the display to display an advertisement content identified based on the obtained viewing group information, obtain feedback information of the user related to the displayed advertisement content, and update the trained first artificial intelligence model to a second artificial intelligence model retrained based on the input context information and the obtained feedback information.

The profile information may include at least one of age, sex, nationality, or a residential area of the user, and the use history information may include at least one of use information for a function of the electronic apparatus, use information for an application installed in the electronic apparatus, and use information for an external apparatus that communicates with the electronic apparatus.

The obtained viewing group information may include at least one of a viewing group representing the user and a probability value corresponding to the at least one of a viewing group representing the user.

The electronic apparatus may further include a communication interface configured to communicate with a server, and the at least one processor may transmit the obtained viewing group information to the server through the communication interface, receive the advertisement content identified based on the obtained viewing group information from the server through the communication interface, and control the display to display the received advertisement content.

The electronic apparatus may further include a communication interface configured to communicate with a server, and the at least one processor may identify viewing groups in a predetermined number based on probability values corresponding to each of a plurality of viewing groups, transmit the identified viewing groups in the predetermined number to the server through the communication interface, and based on receiving at least one advertisement content corresponding to the identified viewing groups in the predetermined number from the server through the communication interface, control the display to display the at least one advertisement content based on probability values corresponding to each of the identified viewing groups in the predetermined number.

The obtained feedback information may include at least one of information on whether an advertisement content is displayed, information on whether the advertisement content was selected, information on whether a service corresponding to the advertisement content was used, information on an accumulated number of times of display of the advertisement content, information on an accumulated number of times of selection of the advertisement content, information on the accumulated number of times of use of the service corresponding to the advertisement content, and information on contribution of the advertisement content.

The at least one processor may identify at least one label information based on the input context information, and update the first artificial intelligence model to a second artificial intelligence model retrained based on the obtained context information, the at least one label information, and the feedback information, and the first artificial intelligence model may being a model trained based on a plurality of training context information, a plurality of training label information, and a plurality of training feedback information for a plurality of advertisement contents.

The electronic apparatus may further include a communication interface configured to communicate with a server, and the at least one processor may transmit first viewing group information obtained through the first artificial intelligence model to the server through the communication interface, and based on receiving a first advertisement content corresponding to the transmitted first viewing group information from the server through the communication interface, control the display to display the first advertisement content in a first style, transmit second viewing group information obtained through the second artificial intelligence model to the server through the communication interface, and based on receiving a second advertisement content corresponding to the second viewing group information from the server through the communication interface, control the display to display the second advertisement content in a second style.

The at least one processor may obtain updated viewing group information of the user by inputting the context information into the second artificial intelligence model, and based on obtaining an advertisement content on a basis of the updated viewing group information, control the display to display the advertisement content and an indicator corresponding to the updated second artificial intelligence model.

The indicator may include at least one of icon information indicating update information, version information of the second artificial intelligence model, and text information indicating an update.

A control method for an electronic apparatus storing a trained first artificial intelligence model according to an embodiment of the disclosure includes the steps of obtaining viewing group information of a user by inputting context information including profile information of the user and use history information of the electronic apparatus into the first artificial intelligence model, displaying an advertisement content identified based on the obtained viewing group information, obtaining feedback information of the user related to the displayed advertisement content, and updating the first artificial intelligence model to a second artificial intelligence model retrained based on the context information and the obtained feedback information.

The profile information may include at least one of age, sex, nationality, or a residential area of the user, and the use history information may include at least one of use information for a function of the electronic apparatus, use information for an application installed in the electronic apparatus, and use information for an external apparatus that communicates with the electronic apparatus.

The viewing group information may include at least one of a viewing group representing the user and a probability value corresponding to the at least one of a viewing group representing the user.

The control method may further include the steps of transmitting the viewing group information to a server configured to communicate with the electronic apparatus, and receiving the advertisement content identified based on the transmitted viewing group information from the server, and in the step of displaying the advertisement content, the received advertisement content may be displayed.

The control method may further include the steps of identifying viewing groups in a predetermined number based on probability values corresponding to each of a plurality of viewing groups, and transmitting the identified viewing groups in the predetermined number to a server configured to communicate with the electronic apparatus, and in the step of displaying the advertisement content, based on receiving at least one advertisement content corresponding to the viewing groups in the predetermined number from the server, the at least one advertisement content may be displayed based on probability values corresponding to each of the viewing groups in the predetermined number.

The feedback information may include at least one of information on whether an advertisement content is displayed, information on whether the advertisement content was selected, information on whether a service corresponding to the advertisement content was used, information on the accumulated number of times of display of the advertisement content, information on the accumulated number of times of selection of the advertisement content, information on the accumulated number of times of use of the service corresponding to the advertisement content, or information on contribution of the advertisement content.

The control method may further include the step of identifying at least one label information based on the context information, and in the updating step, the first artificial intelligence model may be updated to a second artificial intelligence model retrained based on the context information, the at least one label information, and the feedback information, and the first artificial intelligence model may be a model trained based on a plurality of training context information, a plurality of training label information, and a plurality of training feedback information for a plurality of advertisement contents.

The control method may further include the steps of transmitting first viewing group information obtained through the first artificial intelligence model to a server configured to communicate with a server, and based on receiving a first advertisement content corresponding to the first viewing group information from the server, displaying the first advertisement content in a first style, transmitting second viewing group information obtained through the second artificial intelligence model to the server, and based on receiving a second advertisement content corresponding to the second viewing group information from the server, displaying the second advertisement content in a second style.

The control method may further include obtaining updated viewing group information of the user by inputting the context information into the second artificial intelligence model, and based on obtaining an advertisement content on the basis of the updated viewing group information, displaying the advertisement content and an indicator corresponding to the updated second artificial intelligence model.

The indicator may include at least one of icon information indicating update information, version information of the second artificial intelligence model, and text information indicating an update.

### BRIEF DESCRIPTION OF THE DRAWINGS

FIG. 1 is a diagram for illustrating a system providing an advertisement content;

FIG. 2 is a block diagram illustrating an electronic apparatus according to an embodiment of the disclosure;

FIG. 3 is a block diagram for illustrating a detailed configuration of the electronic apparatus in FIG. 2;

FIG. 4 is a flow chart for illustrating an operation of updating an artificial intelligence model;

FIG. 5 is a flow chart for illustrating an operation of updating an artificial intelligence model based on context information and feedback information;

FIG. 6 is a diagram for illustrating an embodiment of storing a first artificial intelligence model and a second artificial intelligence model in an electronic apparatus;

FIG. 7 is a flow chart for illustrating a detailed operation of the embodiment in FIG. 6;

FIG. 8 is a diagram for illustrating an embodiment of storing a first artificial intelligence model and a second artificial intelligence model in a server;

FIG. 9 is a flow chart for illustrating a detailed operation of the embodiment in FIG. 8;

FIG. 10 is a diagram for illustrating an embodiment of updating a second artificial intelligence model in an electronic apparatus;

FIG. 11 is a flow chart for illustrating a detailed operation of the embodiment in FIG. 10;

FIG. 12 is a diagram for illustrating a process of updating an artificial intelligence model by using context information;

FIG. 13 is a diagram for illustrating a process of updating an artificial intelligence model by using feedback information;

FIG. 14 is a diagram for illustrating a process of updating an artificial intelligence model by using context information and feedback information;

FIG. 15 is a flow chart for illustrating an embodiment of providing an advertisement content based on viewing groups in a predetermined number;

FIG. 16 is a diagram for illustrating an operation of providing a plurality of advertisement contents;

FIG. 17 is a flow chart for illustrating an operation of providing advertisement contents based on priorities;

FIG. 18 is a flow chart for illustrating an operation of providing advertisement contents based on probability values;

FIG. 19 is a diagram for illustrating an operation of providing a plurality of advertisement contents in different styles;

FIG. 20 is a diagram for illustrating viewing group information;

FIG. 21 is a flow chart for illustrating an operation of updating an artificial intelligence model based on context information, label information, and feedback information;

FIG. 22 is a table for illustrating context information and label information;

FIG. 23 is a table for illustrating feedback information;

FIG. 24 is a diagram for illustrating a process of calculating contribution;

FIG. 25 is a flow chart for illustrating an operation of providing advertisement contents in different styles according to whether an artificial intelligence model was updated;

FIG. 26 is a diagram for illustrating an operation of displaying a shape of an advertisement content differently;

FIG. 27 is a diagram for illustrating an operation of displaying information indicating whether an artificial intelligence model was updated;

FIG. 28 is a diagram for illustrating an update module related to an artificial intelligence model;

FIG. 29 is a diagram for illustrating a plurality of update modules related to an artificial intelligence model; and

FIG. 30 is a flow chart for illustrating a controlling operation of an electronic apparatus according to an embodiment of the disclosure.

### MODE FOR IMPLEMENTING THE INVENTION

Hereinafter, the disclosure will be described in detail with reference to the accompanying drawings.

As terms used in the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Further, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Also, a plurality of “modules” or “parts” may be integrated into at least one module and implemented as at least one processor (not shown), except “modules” or “parts” which need to be implemented as specific hardware.

Further, in this specification, the term “user” may refer to a person who uses an electronic apparatus or an apparatus using an electronic apparatus (e.g.: an artificial intelligence electronic apparatus).

Hereinafter, an embodiment of the disclosure will be described in more detail with reference to the accompanying drawings.

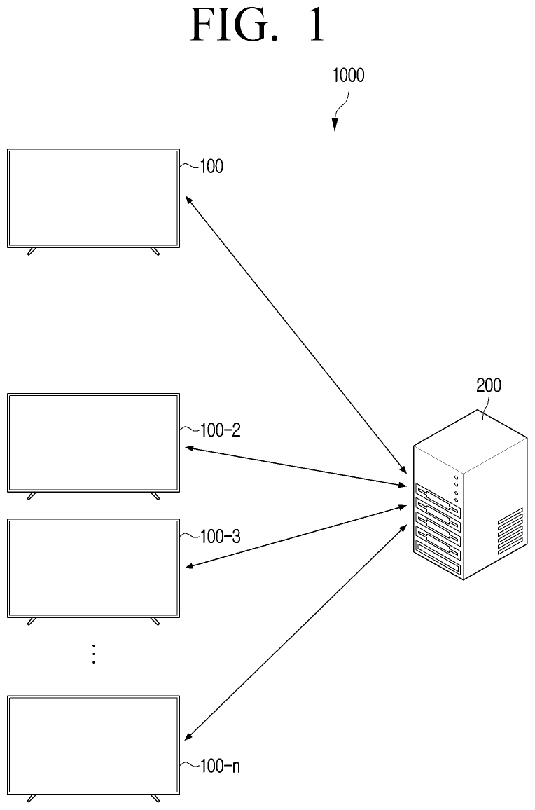

FIG. 1 is a diagram for illustrating a system 1000 providing an advertisement content.

Referring to FIG. 1, the system 1000 may include a plurality of electronic apparatuses 100, 100-2, 100-3, . . . , 100-n and a server 200.

Here, the plurality of electronic apparatuses 100, 100-2, 100-3, . . . , 100-n may mean various apparatuses that display advertisement contents. For example, the plurality of electronic apparatuses 100, 100-2, 100-3, . . . , 100-n may mean apparatuses including displays such as a TV, a smartphone, a wearable device, a signage device, etc.

Here, the server 200 may mean a device that provides advertisement contents. For example, the server 200 may mean a device that stores a plurality of advertisement contents, and provides specific advertisement contents to the plurality of electronic apparatuses 100, 100-2, 100-3, . . . , 100-n.

Also, the server 200 may provide appropriate advertisement contents to each of the plurality of electronic apparatuses 100, 100-2, 100-3, . . . , 100-n. Accordingly, each of the plurality of electronic apparatuses 100, 100-2, 100-3, . . . , 100-n may be provided with different advertisement contents from the server 200.

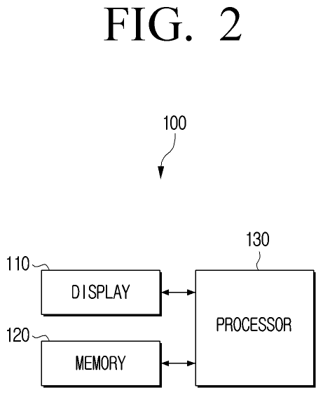

FIG. 2 is a block diagram illustrating the electronic apparatus 100 according to an embodiment of the disclosure.

Referring to FIG. 2, the electronic apparatus 100 may include a display 110, memory 120, or at least one processor 130.

The electronic apparatus 100 may include a display 110, memory 120, and at least one processor 130.

The display 110 may be implemented as displays in various forms such as a liquid crystal display (LCD), an organic light emitting diodes (OLED) display, a plasma display panel (PDP), etc. Inside the display 110, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. Meanwhile, the display 110 may be implemented as a touch screen combined with a touch sensor, a flexible display, a three-dimensional (3D) display, etc. Also, the display 110 according to an embodiment of the disclosure may include not only a display panel outputting images, but also a bezel housing the display panel. In particular, a bezel according to an embodiment of the disclosure may include a touch sensor (not shown) for detecting user interactions.

The memory 120 may be implemented as internal memory such as ROM (e.g., electrically erasable programmable read-only memory (EEPROM)), RAM, etc., included in the processor 130, or implemented as separate memory from the processor 130. In this case, the memory 120 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

Meanwhile, in the case of memory embedded in the electronic apparatus 100, the memory may be implemented as at least one of volatile memory (e.g.: dynamic RAM (DRAM), static RAM (SRAM) or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). In the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), external memory that can be connected to a USB port (e.g., a USB memory), etc.

Here, the memory 120 may store a trained first artificial intelligence model.

The at least one processor 130 may perform overall controlling operations of the electronic apparatus 100. Specifically, the at least one processor 130 performs a function of controlling overall operations of the electronic apparatus 100.

The at least one processor 130 may be implemented as a digital signal processor (DSP) processing digital signals, a microprocessor, and a time controller (TCON). However, the disclosure is not limited thereto, and the processor 130 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the processor 130 may be implemented as a system on chip (SoC) having a processing algorithm stored therein or large scale integration (LSI), or implemented in the form of a field programmable gate array (FPGA). Further, the processor 130 may perform various functions by executing computer executable instructions stored in the memory 120.

The at least one processor 130 may obtain viewing group information of a user by inputting context information including profile information of the user and use history information of the electronic apparatus into a first artificial intelligence model, control the display 110 to display an advertisement content identified based on the viewing group information, obtain feedback information of the user related to the displayed advertisement content, and update the first artificial intelligence model to a second artificial intelligence model retrained based on the context information and the feedback information.

Here, the at least one processor 130 may obtain the viewing group information by using a first artificial intelligence model. The at least one processor 130 may input (or apply) context information to the first artificial intelligence model as input data, and obtain the viewing group information as output data.

Here, the context information may mean various kinds of information obtained in the electronic apparatus 100. The context information may mean information related to a user's behavior. Also, the context information may include at least one of profile information or use history information.

Meanwhile, the profile information may include at least one of the age, the sex, the nationality, or the residential area of the user. Also, the profile information may include personal information of the user.

The use history information may include at least one of use information for a function of the electronic apparatus, use information for an application installed in the electronic apparatus, or use information for an external apparatus that communicates with the electronic apparatus.

The use information for a function of the electronic apparatus (or function use information) may be information indicating a use history of the user related to at least one function (e.g., output of a broadcasting signal) provided in the electronic apparatus 100. For example, the function use information may include information regarding when and how much the user used a function of the electronic apparatus 100.

The use information for an application installed in the electronic apparatus (or application use information) may be information indicating a use history of the user related to an application (e.g., a video platform application) installed in the electronic apparatus 100. For example, the application use information may include information regarding when and how much the user used an application installed in the electronic apparatus 100.

The use information for an external apparatus that communicates with the electronic apparatus (or external apparatus use information) may be information indicating a use history of the user related to an external apparatus (e.g., a game consol) that can be connected with the electronic apparatus 100 wirelessly or via wire. For example, the external apparatus use information may include information regarding when and how much the user used an external apparatus connected to the electronic apparatus 100.

Meanwhile, the context information may additionally include accumulated feedback information. The accumulated feedback information may include feedback information for an advertisement content provided at the electronic apparatus. The feedback information mentioned below may be included in the context information.

The at least one processor 130 may obtain data for a behavior of the user using the electronic apparatus 100 as the context information. Then, the at least one processor 130 may obtain viewing group information corresponding to the context information based on the first artificial intelligence model.

Here, the viewing group information may mean representative data indicating the user using the electronic apparatus 100. Here, the viewing group information may also be described as representative data, user characteristic data, similar group information, etc. Here, the viewing group information may include a specific viewing group and a probability value corresponding to the specific viewing group.

The viewing group information may include at least one of a viewing group representing the user or a probability value corresponding to the viewing group representing the user.

The first artificial intelligence model may store a plurality of predetermined viewing groups. Then, the first artificial intelligence model may output a probability value for a specific viewing group among the plurality of stored viewing groups based on input data. For example, the first artificial intelligence model may receive context information of a first apparatus as input data, and output soccer (the probability value: 90) which is the viewing group representing the first apparatus as output data.

When the viewing group information is specified, the at least one processor 130 may obtain an advertisement content corresponding to the viewing group information. As the viewing group information is data that can represent the user, an advertisement content that is the most appropriate for the user may be determined based on the viewing group information.

The at least one processor 130 may receive an advertisement content through a server 200. Here, the server 200 may also be described as an external apparatus or an external device, etc.

Meanwhile, the electronic apparatus 100 may further include a communication interface 140 that communicates with the server 200. The at least one processor 130 may transmit viewing group information to the server 200 through the communication interface 140, receive an advertisement content identified based on the viewing group information from the server 200 through the communication interface 140, and control the display 110 to display the received advertisement content.

The server 200 may identify an advertisement content based on the viewing group information received from the electronic apparatus 100. Then, the server 200 may transmit the identified advertisement content to the electronic apparatus 100.

Not only the aforementioned embodiment, but also operations necessary for providing an advertisement content to the user may be performed while being divided in the electronic apparatus 100 or the server 200, etc. according to various embodiments.

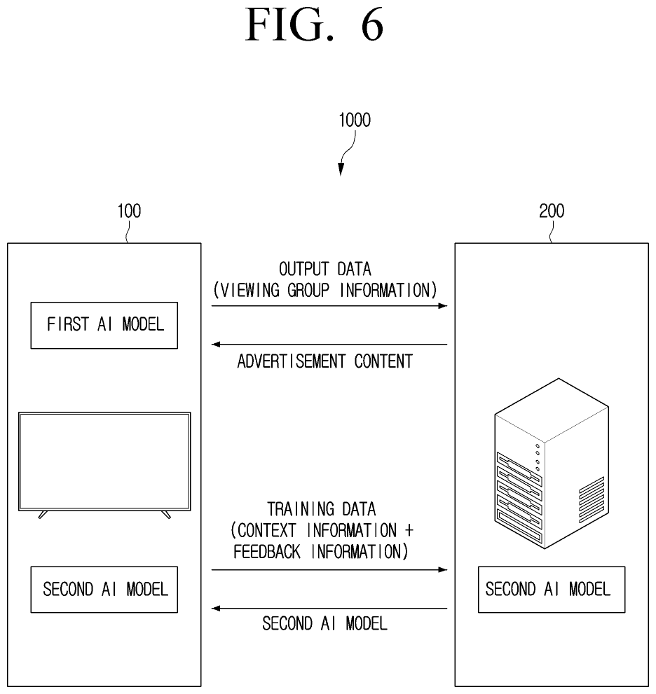

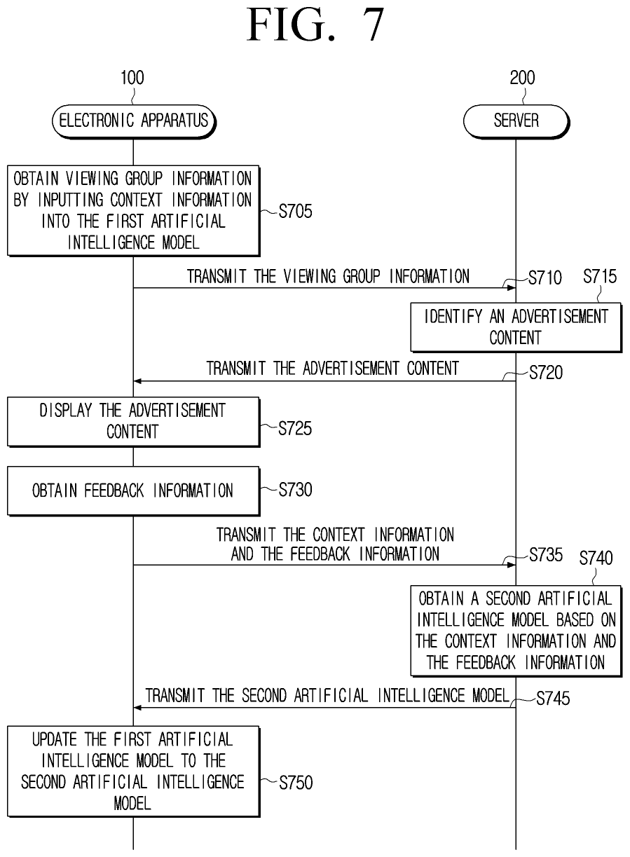

According to an embodiment, the electronic apparatus 100 may obtain context information and viewing group information, and the server 200 may determine an advertisement content. The artificial intelligence model used in obtaining the viewing group information may be updated in the server 200. Detailed explanation in this regard will be described in FIG. 6 and FIG. 7.

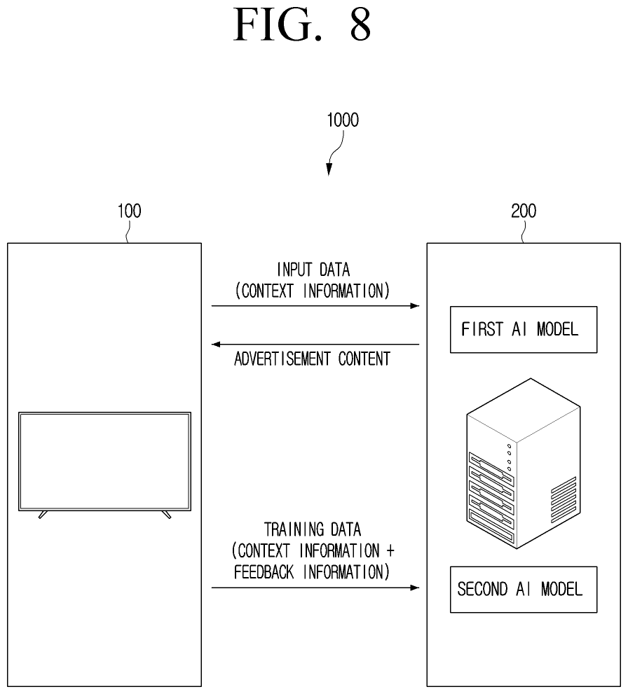

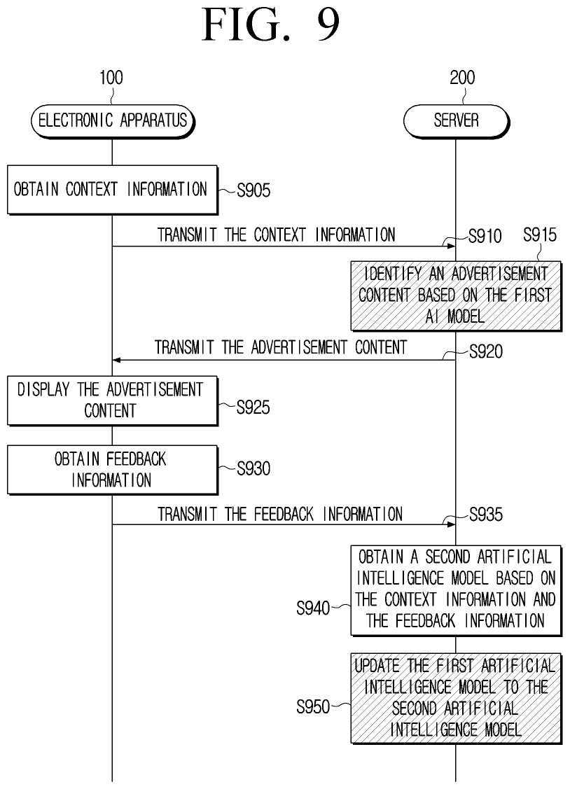

According to another embodiment, the electronic apparatus 100 may obtain context information, and the server 200 may obtain viewing group information, and determine an advertisement content. The artificial intelligence model used in obtaining the viewing group information may be updated in the server 200. Detailed explanation in this regard will be described in FIG. 8 and FIG. 9.

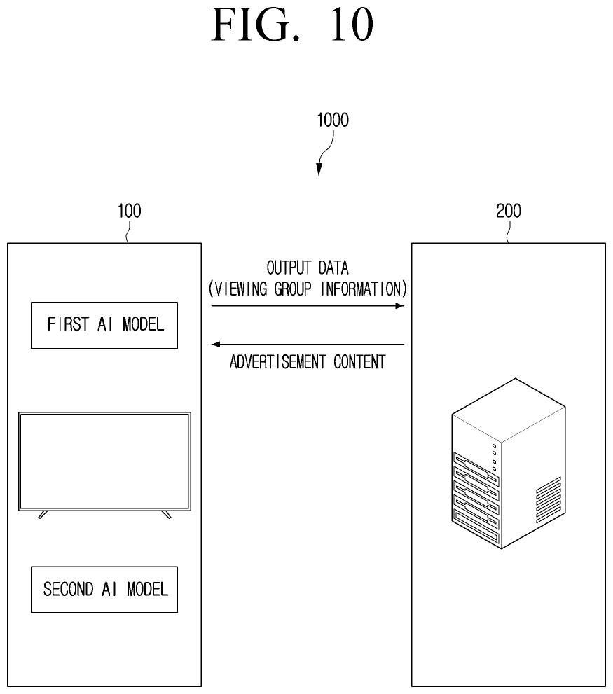

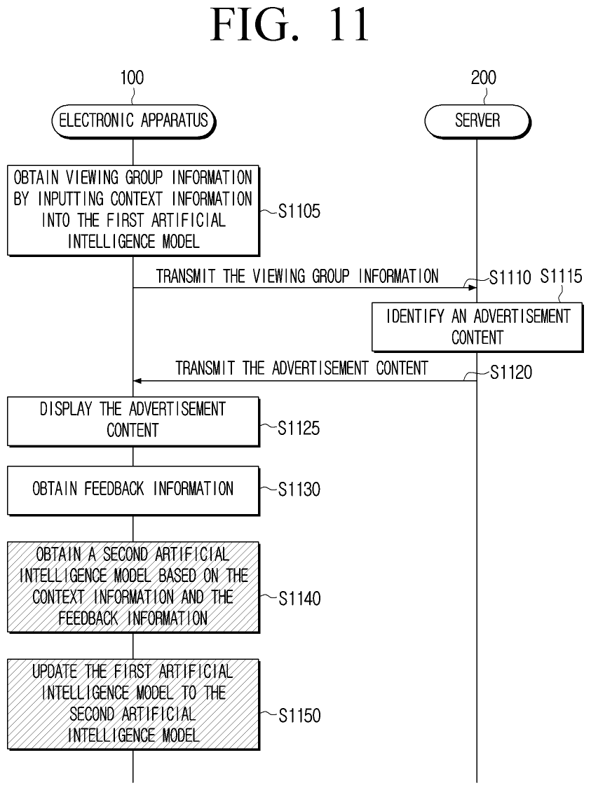

According to another embodiment, the electronic apparatus 100 may obtain context information and viewing group information, and the server 200 may determine an advertisement content. The artificial intelligence model used in obtaining the viewing group information may be updated in the electronic apparatus 100. Detailed explanation in this regard will be described in FIG. 10 and FIG. 11.

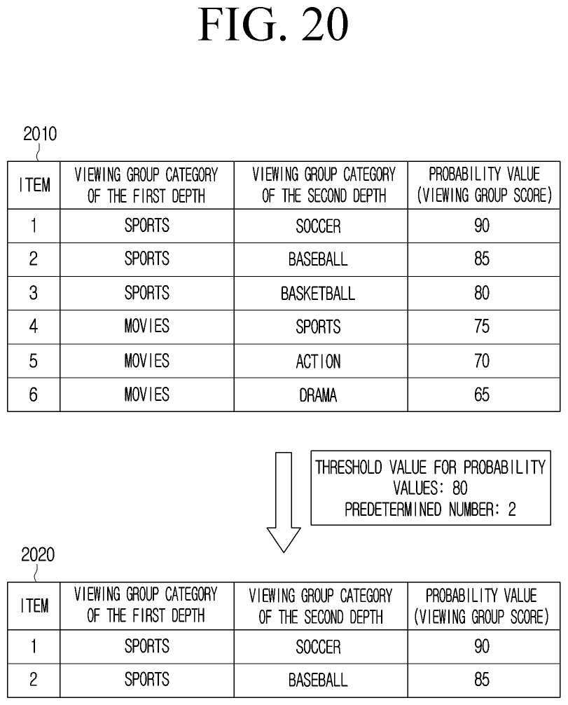

Meanwhile, the viewing group information may include information on a plurality of viewing groups. The viewing group information may include a plurality of viewing groups and probability values corresponding to each of the plurality of viewing groups. Information on the plurality of viewing groups will be described in the table 2010 in FIG. 20.

Meanwhile, the at least one processor 130 may identify viewing groups in a predetermined number based on the probability values corresponding to each of the plurality of viewing groups, transmit the viewing groups in the predetermined number to the server 200 through the communication interface 140, and when at least one advertisement content corresponding to the viewing groups in the predetermined number is received from the server 200 through the communication interface 140, control the display 110 to display the at least one advertisement content based on probability values corresponding to each of the viewing groups in the predetermined number.

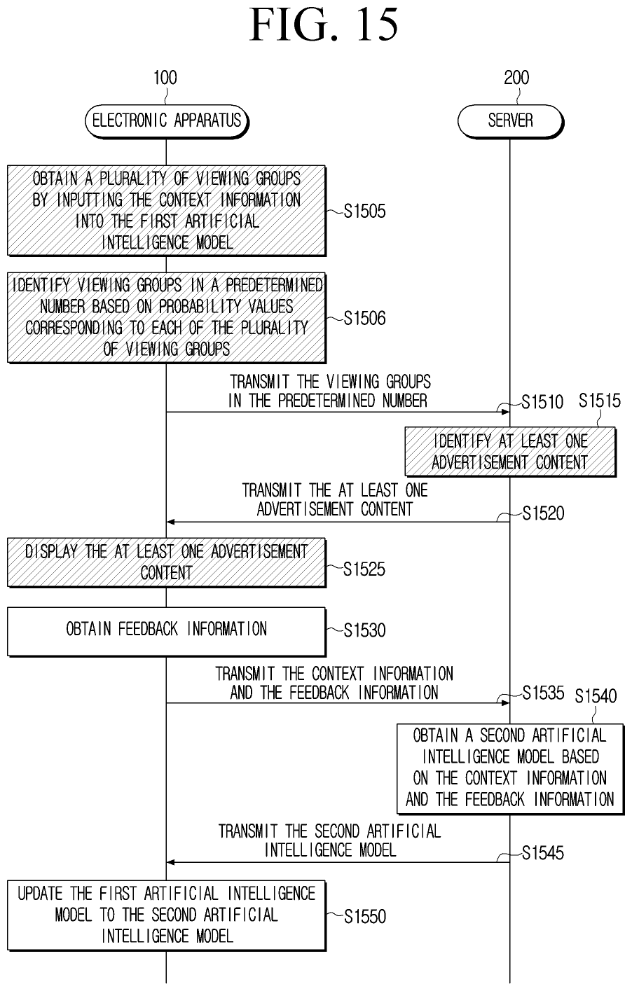

An operation of using viewing groups in the predetermined number will be described in detail in FIG. 15 and FIG. 20.

Here, the at least one processor 130 may obtain information on the plurality of viewing groups (the viewing group information) through the first artificial intelligence model. Then, the at least one processor 130 may transmit the information on the plurality of viewing groups to the server 200.

The server 200 may identify at least one advertisement content based on the information on the plurality of viewing groups received from the electronic apparatus 100.

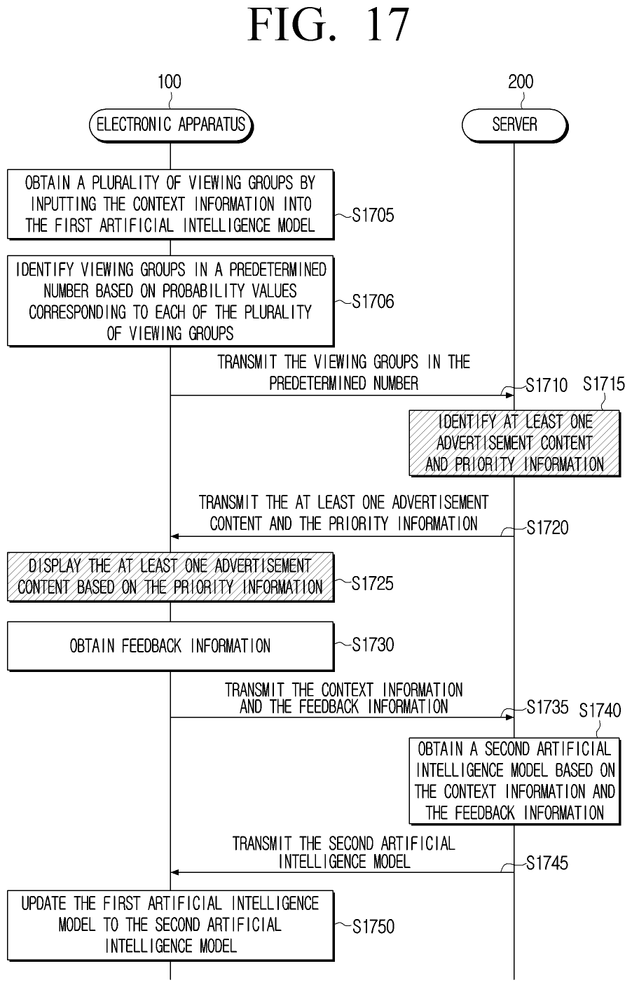

According to an embodiment, the server 200 may obtain at least one advertisement content and priority information. The server 200 may obtain the priority information together in the case of identifying two or more advertisement contents. The server 200 may transmit the two or more advertisement contents and the priority information to the electronic apparatus 100. An operation in this regard will be described in FIG. 17.

According to another embodiment, the server 200 may identify advertisement contents in a predetermined number. Then, the server 200 may map viewing groups in the predetermined number and the advertisement contents in the predetermined number. For example, the server 200 may generate (or obtain) a mapping table including result data of mapping a first viewing group (soccer) and a first advertisement content (an advertisement of a soccer ball), and mapping a second viewing group (baseball) and a second advertisement content (an advertisement of a baseball).

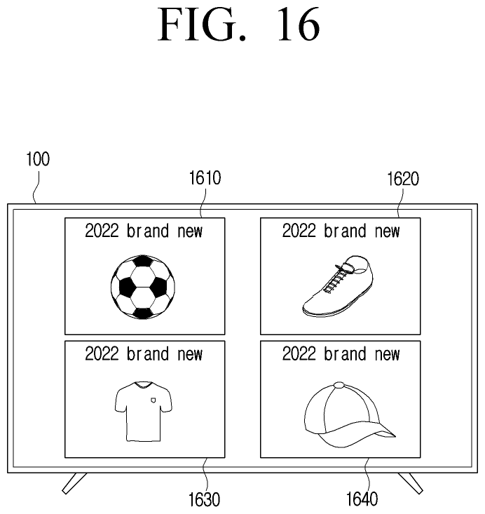

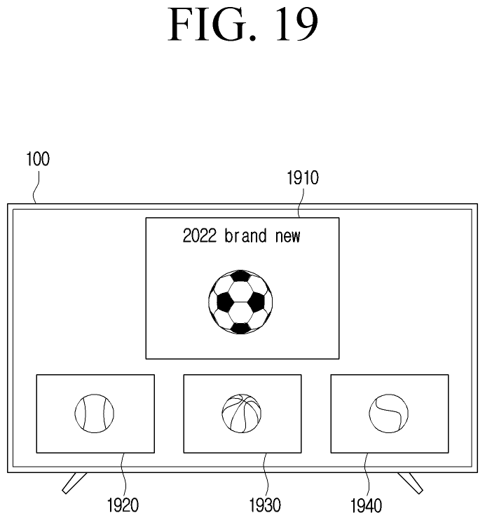

A method of displaying a plurality of advertisement contents will be described in FIG. 16 and FIG. 19. In particular, an embodiment of displaying advertisement contents in different sizes based on probability values corresponding to each of the viewing groups will be described in FIG. 19.

Meanwhile, the at least one processor 130 may update the artificial intelligence model based on at least one of the context information or the feedback information. Specifically, the at least one processor 130 may obtain a second artificial intelligence model by using at least one of the context information or the feedback information.

Meanwhile, the feedback information may include at least one of information on whether an advertisement content is displayed, information on whether the advertisement content was selected, information on whether a service corresponding to the advertisement content was used, information on the accumulated number of times of display of the advertisement content, information on the accumulated number of times of selection of the advertisement content, information on the accumulated number of times of use of the service corresponding to the advertisement content, or information on contribution of the advertisement content.

An operation of generating the second artificial intelligence model itself may be performed in the server 200 or the electronic apparatus 100.

According to an embodiment, the operation of obtaining the second artificial intelligence model may be performed in the server 200. Explanation in this regard will be described in FIG. 6 to FIG. 9.

According to another embodiment, the operation of obtaining the second artificial intelligence model may be performed in the electronic apparatus 100. Explanation in this regard will be described in FIG. 10 to FIG. 11.

Meanwhile, in the aforementioned explanation, it was described that the context information and the feedback information are used in the updating operation.

According to various embodiments, label information may be used in the updating operation.

According to an embodiment, the context information and the feedback information may be used in the updating operation.

According to another embodiment, the label information and the feedback information may be used in the updating operation.

According to still another embodiment, the context information, the label information, and the feedback information may be used in the updating operation.

Meanwhile, the at least one processor 130 may identify at least one label information based on the context information, and update the first artificial intelligence model to a second artificial intelligence model retrained based on the context information, the at least one label information, and the feedback information, and the first artificial intelligence model may be a model trained based on a plurality of training context information, a plurality of training label information, and a plurality of training feedback information for a plurality of advertisement contents.

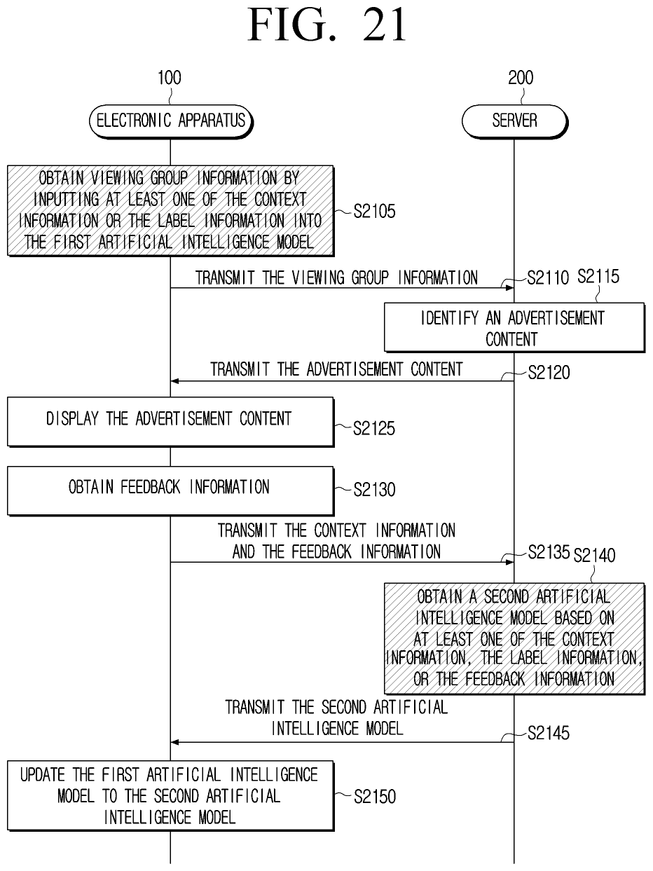

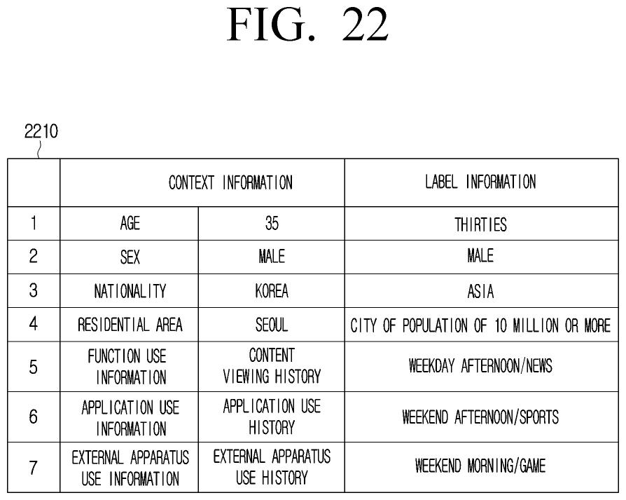

The label information may mean representative data determined based on the context information. At least one label information may be included for each user or each device. The label information may mean information wherein the context information was specified to any one group among a plurality of pre-stored groups. Detailed explanation related to the label information will be described in FIG. 21 and FIG. 22.

Meanwhile, the at least one processor 130 may transmit first viewing group information obtained through the first artificial intelligence model to the server 200 through the communication interface 140, and based on receiving a first advertisement content corresponding to the first viewing group information from the server 200 through the communication interface 140, control the display 110 to display the first advertisement content in a first style, transmit second viewing group information obtained through the second artificial intelligence model to the server 200 through the communication interface 140, and based on receiving a second advertisement content corresponding to the second viewing group information from the server 200 through the communication interface 140, control the display 110 to display the second advertisement content in a second style.

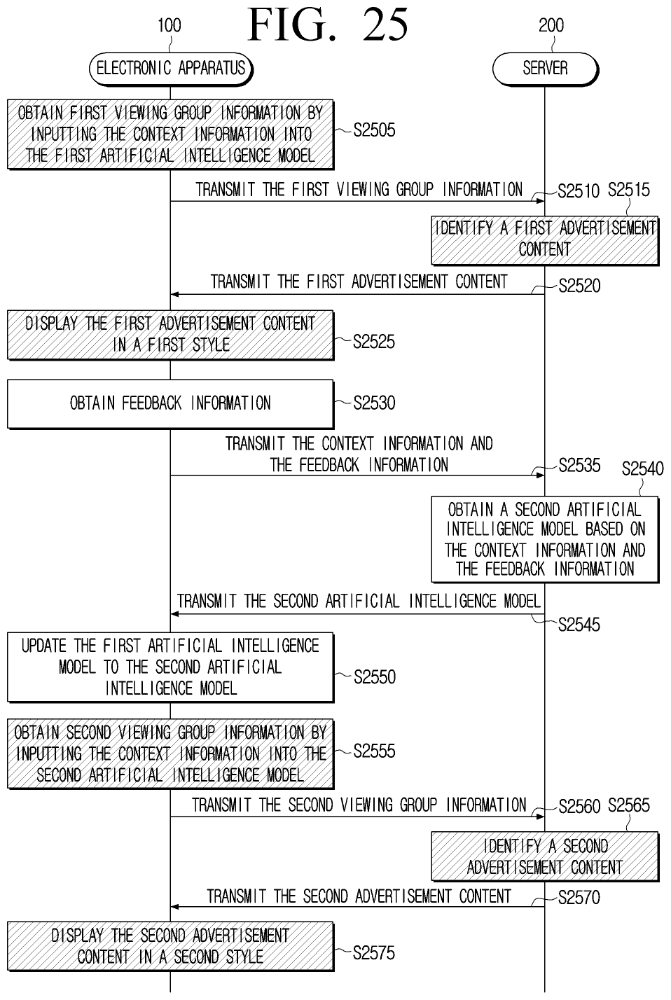

The first style and the second style may be different styles. For example, in the first style and the second style, shapes of areas wherein advertisement contents are displayed may be different. Also, the first style and the second style may be different regarding whether an indicator indicating if update was performed is included. Detailed explanation related to the styles will be described in FIG. 25 to FIG. 27.

Meanwhile, the at least one processor 130 may obtain updated viewing group information of the user by inputting the context information into the second artificial intelligence model, and based on obtaining an advertisement content on the basis of the updated viewing group information, control the display to display the advertisement content and an indicator corresponding to the updated viewing group information.

In providing an advertisement content in a specific style, the at least one processor 130 may display an indicator indicating the updated second artificial intelligence model together other than an advertisement content.

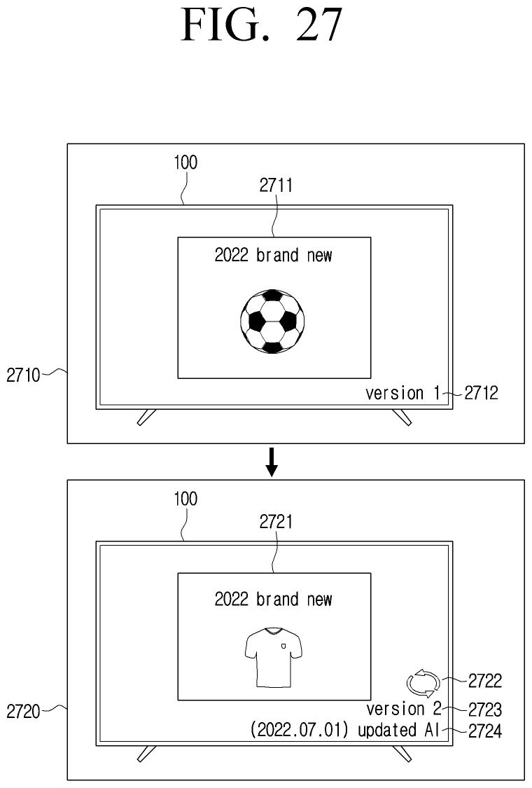

Meanwhile, the indicator may include at least one of icon information indicating update, version information of the second artificial intelligence model, or text information indicating update. A specific operation related to an operation of displaying an indicator will be described in FIG. 27.

The icon information indicating update (e.g., 2722 in FIG. 27) may include an icon indicating update.

The version information of the artificial intelligence model (e.g., 2723 in FIG. 27) may mean information indicating the stage of development of the software of the current artificial intelligence model.

The text information indicating update (e.g., 2724 in FIG. 27) may include a text indicating update.

Meanwhile, in the aforementioned explanation, it was described that the output data of the artificial intelligence model is the viewing group information. However, according to another implementation example, the output data of the first artificial intelligence model may be an advertisement content. Specifically, the first artificial intelligence model may directly output an advertisement content as the output data based on the context information which is the input data.

Meanwhile, in the aforementioned explanation, it was described that the artificial intelligence model is updated based on the context information and the feedback information obtained in the electronic apparatus 100. However, the artificial intelligence model may be updated in consideration of the context information and the feedback information obtained from a terminal apparatus of another user as well as the electronic apparatus 100.

Meanwhile, the electronic apparatus 100 according to various embodiments may update the artificial intelligence model for obtaining viewing group information representing the user based on the feedback information.

Here, the updating operation may be in consideration of not only the user's behavior related to the apparatus, but also the user's behavior related to an advertisement. Accordingly, the updated artificial intelligence model may be retrained to be specified for the individual user.

As the updating operation for reflecting the user's behavior is performed automatically, management by the manager or the user can become easy. Also, as update is repeated, the user's behavior is applied more, and thus the user's satisfaction for output data can be improved, and the target performance of providing an appropriate advertisement can be improved.

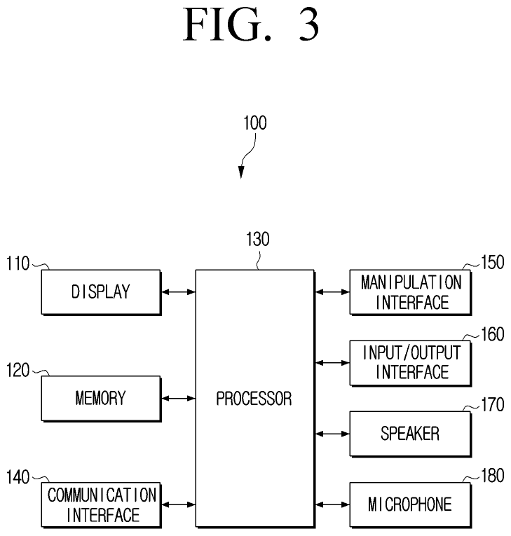

Meanwhile, in the above, only simple components constituting the electronic apparatus 100 were illustrated and explained, but various components can be additionally provided in actual implementation. Explanation in this regard will be described below with reference to FIG. 3.

FIG. 3 is a block diagram for illustrating a detailed configuration of the electronic apparatus 100 in FIG. 2.

Referring to FIG. 3, the electronic apparatus 100 may include at least one of a display 110, memory 120, at least one processor 130, a communication interface 140, a manipulation interface 150, an input/output interface 160, a speaker 170, or a microphone 180.

Meanwhile, among the operations of the display 110, the memory 120, and the at least one processor 130, regarding operations identical to those explained above, overlapping explanation will be omitted.

The communication interface 140 is a component that performs communication with various types of external apparatuses according to various types of communication methods. The communication interface 140 may include a wireless communication module or a wired communication module. Here, each communication module may be implemented in a form of at least one hardware chip.

A wireless communication module may be a module that communicates with an external apparatus wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external apparatus via wire. For example, a wired communication module may include at least one of a local area network (LAN) module, an Ethernet module, a pair cable, a coaxial cable, an optical fiber cable, or an ultra wide-band (UWB) module.

The manipulation interface 150 may be implemented as an apparatus like a button, a touch pad, a mouse, and a keyboard, or implemented as a touch screen that can perform both of the aforementioned display function and a manipulation input function. Here, a button may be various types of buttons such as a mechanical button, a touch pad, a wheel, etc. formed in any areas such as the front surface part, the side surface part, the rear surface part, etc. of the exterior of the main body of the electronic apparatus 100.

The input/output interface 160 may be the interface of any one of a high definition multimedia interface (HDMI), a mobile high-definition link (MHL), a universal serial bus (USB), a display port (DP), a Thunderbolt, a video graphics array (VGA) port, an RGB port, a D-subminiature (D-SUB), or a digital visual interface (DVI). The input/output interface 160 may input or output at least one of an audio signal or a video signal. Depending on implementation examples, the input/output interface 160 may include a port outputting only audio signals and a port outputting only video signals as separate ports, or it may be implemented as one port that inputs and outputs both audio signals and video signals. Meanwhile, the electronic apparatus 100 may transmit at least one of an audio signal or a video signal to an external apparatus (e.g., an external display apparatus or an external speaker) through the input/output interface 160. Specifically, an output port included in the input/output interface 160 may be connected with an external apparatus, and the electronic apparatus 100 may transmit at least one of an audio signal or a video signal to the external apparatus through the output port.

Here, the input/output interface 160 may be connected with the communication interface 140. The input/output interface 160 may transmit information received from an external apparatus to the communication interface 140, or transmit information received through the communication interface 140 to the external apparatus.

The speaker 170 may be a component that outputs not only various kinds of audio data but also various kinds of notification sounds or voice messages, etc.

The microphone 180 is a component for receiving input of a user voice or other sounds and converting them into audio data. The microphone 180 may receive a voice of a user in an activated state. For example, the microphone 180 may be formed as an integrated type on the upper side or the front surface direction, the side surface direction, etc. of the electronic apparatus 100. The microphone 180 may include various components such as a microphone collecting a user voice in an analogue form, an amp circuit amplifying the collected user voice, an A/D conversion circuit that samples the amplified user voice and converts the user voice into a digital signal, a filter circuit that removes noise components from the converted digital signal, etc.

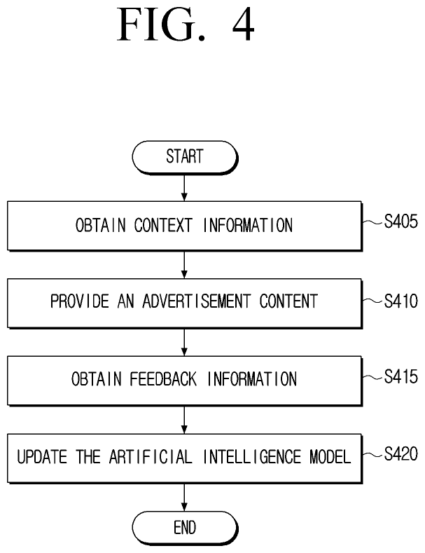

FIG. 4 is a flow chart for illustrating an operation of updating an artificial intelligence model.

Referring to FIG. 4, the electronic apparatus 100 may obtain context information in operation S405. The context information may mean various types of information obtained at the electronic apparatus 100. Also, the context information may mean various types of information related to the user's behavior.

Also, the electronic apparatus 100 may provide an advertisement content in operation S410. The electronic apparatus 100 may obtain an advertisement content based on the context information. The context information may be used for providing the most appropriate advertisement content to the user. The electronic apparatus 100 may provide an advertisement content corresponding to the context information based on the artificial intelligence model. Specifically, the electronic apparatus 100 may input (apply) the context information to the artificial intelligence model as input data. The electronic apparatus 100 may obtain the viewing group information from the artificial intelligence model as output data. The electronic apparatus 100 may obtain an advertisement content based on the obtained viewing group information. An advertisement content appropriate for the user may be determined based on the viewing group information.

Also, the electronic apparatus 100 may obtain feedback information in operation S415. The electronic apparatus 100 may obtain feedback information related to the advertisement content provided in the operation S410. The feedback information may mean information related to provision, selection, or use of an advertisement content.

Also, the electronic apparatus 100 may update the artificial intelligence model in operation S420. The electronic apparatus 100 may update the artificial intelligence model based on at least one of the context information or the feedback information. The updated artificial intelligence model may be a model that is used in obtaining the viewing group information based on the context information.

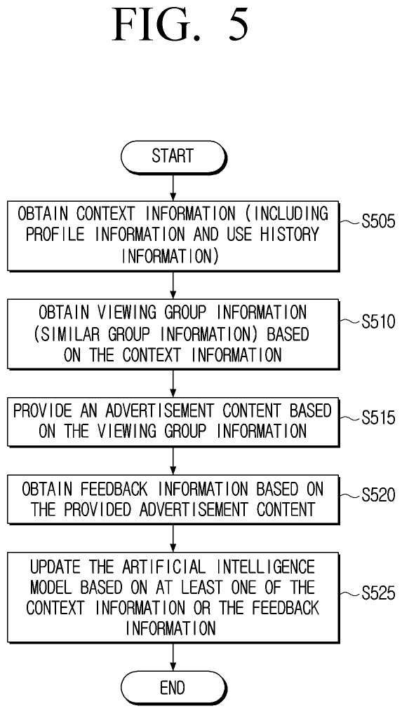

FIG. 5 is a flow chart for illustrating an operation of updating an artificial intelligence model based on context information and feedback information.

Referring to FIG. 5, the electronic apparatus 100 may obtain context information including at least one of profile information or use history information in operation S505.

The profile information may mean information related to the personal information of the user. For example, the profile information may include at least one of the age, the sex, the nationality, or the residential area of the user.

The use history information may mean information regarding how the user used the electronic apparatus 100. For example, the use history information may include at least one of use information for a function of the electronic apparatus, use information for an application installed in the electronic apparatus, use information for an external apparatus that communicates with the electronic apparatus, or feedback information for an advertisement content provided in the electronic apparatus.

Also, the electronic apparatus 100 may obtain viewing group information based on the context information in operation S510. The viewing group information may include representative data indicating the user who used the electronic apparatus 100. The viewing group information may also be described as similar group information. The electronic apparatus 100 may identify the viewing group information of the user based on the context information. The electronic apparatus 100 may obtain the viewing group information based on the artificial intelligence model.

Also, the electronic apparatus 100 may provide an advertisement content based on the viewing group information in operation S515. The advertisement content may be a content corresponding to the viewing group information. Also, the advertisement content may be a content that is highly likely to be preferred by the user. The viewing group information may be used for determining whether the user likes a content.

In addition, the electronic apparatus 100 may obtain feedback information based on the provided advertisement content in operation S520. The feedback information may include feedback data of the user regarding the provided advertisement content.

Also, the electronic apparatus 100 may update the artificial intelligence model based on at least one of the context information or the feedback information in operation S525. The electronic apparatus 100 may update the artificial intelligence model by using at least one of the context information indicating how the user used the electronic apparatus 100 or the feedback information indicating how the user viewed the advertisement content.

FIG. 6 is a diagram for illustrating an embodiment of storing a first artificial intelligence model and a second artificial intelligence model in the electronic apparatus 100.

Referring to FIG. 6, the electronic apparatus 100 may store the first artificial intelligence model. The electronic apparatus 100 may transmit the viewing group information of the user to the server 200. The server 200 may transmit an advertisement content corresponding to the viewing group information to the electronic apparatus 100.

Here, the electronic apparatus 100 may provide the advertisement content received from the server 200 to the user, and obtain feedback information for the advertisement content. The electronic apparatus 100 may transmit the context information and the feedback information to the server 200.

Here, the server 200 may update the artificial intelligence model by using the context information and the feedback information as training data. The server 200 may transmit the updated second artificial intelligence model to the electronic apparatus 100.

Afterwards, the electronic apparatus 100 may obtain the viewing group information based on the second artificial intelligence model.

FIG. 7 is a flow chart for illustrating a detailed operation of the embodiment in FIG. 6.

Referring to FIG. 7, the electronic apparatus 100 may obtain viewing group information by inputting the context information into the first artificial intelligence model in operation S705. The electronic apparatus 100 may transmit the viewing group information to the server 200 in operation S710.

Here, the server 200 may receive the viewing group information from the electronic apparatus 100. The server 200 may identify an advertisement content based on the viewing group information in operation S715. The server 200 may transmit the identified advertisement content to the electronic apparatus 100 in operation S720.

Here, the electronic apparatus 100 may receive the advertisement content from the server 200. The electronic apparatus 100 may display the advertisement content in operation S725. The electronic apparatus 100 may obtain feedback information corresponding to the displayed advertisement content in operation S730. The electronic apparatus 100 may transmit the context information and the feedback information to the server 200 in operation S735.

Here, the server 200 may receive the context information and the feedback information from the electronic apparatus 100. The server 200 may obtain the second artificial intelligence model based on the context information and the feedback information in operation S740. The server 200 may transmit the second artificial intelligence model to the electronic apparatus 100 in operation S745.

Here, the electronic apparatus 100 may receive the second artificial intelligence model from the server 200. The electronic apparatus 100 may update the first artificial intelligence model to the second artificial intelligence model in operation S750. The electronic apparatus 100 may obtain the viewing group information by using the second artificial intelligence model instead of the first artificial intelligence model.

FIG. 8 is a diagram for illustrating an embodiment of storing a first artificial intelligence model and a second artificial intelligence model in the server 200.

Referring to FIG. 8, the artificial intelligence model may be stored in the server 200. The electronic apparatus 100 may transmit the context information to the server 200. Here, the transmitted context information may be used in the server 200 as input data. The server 200 may determine an advertisement content appropriate for the electronic apparatus 100 by inputting the context information into the first artificial intelligence model.

Also, the server 200 may update the artificial intelligence model by receiving training data from the electronic apparatus 100. The training data may include context information and feedback information. The server 200 may update the first artificial intelligence model to the second artificial intelligence model by using the training data. Here, the updating operation may be a retraining operation.

Afterwards, the server 200 may obtain the viewing group information based on the second artificial intelligence model.

FIG. 9 is a flow chart for illustrating a detailed operation of the embodiment in FIG. 8.

The operations S905, S920, S925, S930, and S940 in FIG. 9 may correspond to the operations S705, S720, S725, S730, and S740 in FIG. 7. Accordingly, overlapping explanation will be omitted.

After obtaining the context information in operation S905, the electronic apparatus 100 may transmit the context information to the server 200 in operation S910.

The server 200 may receive the context information from the electronic apparatus 100. The server 200 may identify an advertisement content based on the first artificial intelligence model in operation S915. Specifically, the server 200 may identify an advertisement content by inputting the context information received from the electronic apparatus 100 into the first artificial intelligence model. The server 200 may obtain the viewing group information as output data by inputting the context information into the first artificial intelligence model as input data, and identify an advertisement content corresponding to the viewing group information. The server 200 may transmit the advertisement content to the electronic apparatus 100 in operation S920. The electronic apparatus 100 may display the advertisement content received from the server 200 in operation S925. The electronic apparatus 100 may obtain feedback information corresponding to the displayed advertisement content in operation S930.

Also, after obtaining the feedback information, the electronic apparatus 100 may transmit the feedback information to the server 200 in operation S935. The server 200 may receive the feedback information from the electronic apparatus 100. The server 200 may obtain the second artificial intelligence model based on the context information and the feedback information in operation S940. The server 200 may update the first artificial intelligence model to the second artificial intelligence model in operation S950.

FIG. 10 is a diagram for illustrating an embodiment of updating a second artificial intelligence model in the electronic apparatus 100.

Referring to FIG. 10, the electronic apparatus 100 may directly update the artificial intelligence model. The electronic apparatus 100 may obtain the viewing group information by storing the first artificial intelligence model. The server 200 may determine an advertisement content by receiving the viewing group information from the electronic apparatus 100. The electronic apparatus 100 may be provided with the advertisement content from the server 200, and display the advertisement content.

Also, the electronic apparatus 100 may update the first artificial intelligence model to the second artificial intelligence model based on the feedback information corresponding to the displayed advertisement content.

FIG. 11 is a flow chart for illustrating a detailed operation of the embodiment in FIG. 10.

The operations S1105, S1110, S1115, S1120, S1125, and S1130 in FIG. 11 may correspond to the operations S705, S710, S715, S720, S725, and S730 in FIG. 7. Accordingly, overlapping explanation will be omitted.

After obtaining feedback information in operation S1130, the electronic apparatus 100 may obtain a second artificial intelligence model based on the context information and the feedback information in operation S1140. Then, the electronic apparatus 100 may update the first artificial intelligence model to the second artificial intelligence model in operation S1150.

In FIG. 6 to FIG. 9, it was described that an operation of updating the artificial intelligence model is performed in the server 200. However, the artificial intelligence model may be retrained in the electronic apparatus 100 itself. As the artificial intelligence model is retrained by using only the data of the electronic apparatus 100, the electronic apparatus 100 may obtain the second artificial intelligence model appropriate for an individual user.

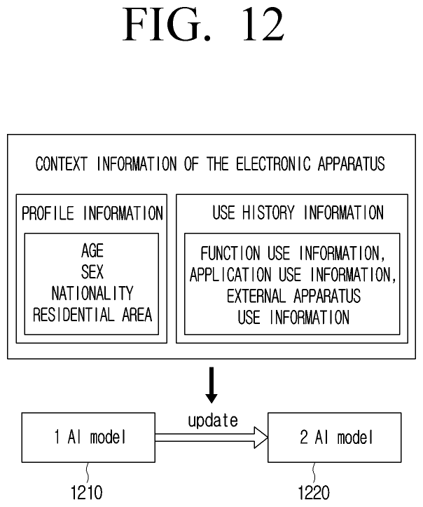

FIG. 12 is a diagram for illustrating a process of updating an artificial intelligence model by using context information.

Referring to FIG. 12, the electronic apparatus 100 may update the first artificial intelligence model 1210 to the second artificial intelligence model 1220. Here, the second artificial intelligence model 1220 may be a model that was retrained based on the context information. The electronic apparatus 100 may update the first artificial intelligence model 1210 to the second artificial intelligence model 1220 based on the context information of the electronic apparatus 100.

Here, the context information may include at least one of profile information or use history information. The profile information may include at least one of the age, the sex, the nationality, or the residential area of the user.

Here, the use history information may include at least one of use information for a function, use information for an application, or use information for an external apparatus.

Specifically, the use information for a function may be information indicating a use history of the user related to at least one function (e.g., output of a broadcasting signal) provided in the electronic apparatus 100. For example, the function use information may include information regarding when and how much the user used a function of the electronic apparatus 100.

Also, the use information for an application may be information indicating a use history of the user related to an application (e.g., a video platform application) installed in the electronic apparatus 100. For example, the application use information may include information regarding when and how much the user used an application installed in the electronic apparatus 100.

In addition, the use information for an external apparatus may be information indicating a use history of the user related to an external apparatus (e.g., a game consol) that can be connected with the electronic apparatus 100 wirelessly or via wire. For example, the external apparatus use information may include information regarding when and how much the user used an external apparatus connected to the electronic apparatus 100.

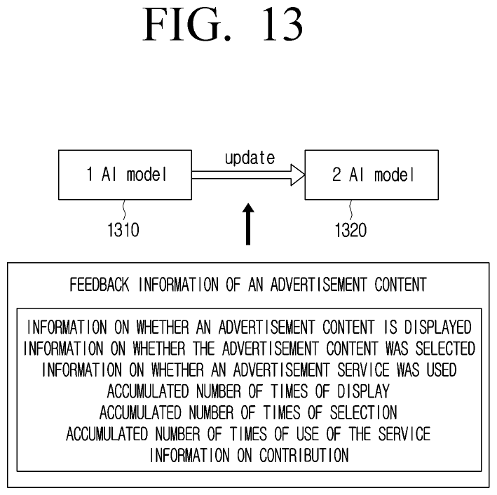

FIG. 13 is a diagram for illustrating a process of updating an artificial intelligence model by using feedback information.

Referring to FIG. 13, the electronic apparatus 100 may update the first artificial intelligence model 1310 to the second artificial intelligence model 1320. Here, the second artificial intelligence model 1320 may be model that was retrained based on the feedback information. The electronic apparatus 100 may update the first artificial intelligence model 1310 to the second artificial intelligence model 1320 based on the feedback information of an advertisement content.

Here, the feedback information may include at least one of information on whether an advertisement content is displayed, information on whether the advertisement content was selected, information on whether an advertisement service was used, information on the accumulated number of times of display, information on the accumulated number of times of selection, information on the accumulated number of times of use of the service, or information on contribution.

Specifically, the information on whether an advertisement content is displayed may indicate information regarding whether an advertisement content is displayed on the electronic apparatus 100.

Also, the information on whether the advertisement content was selected may indicate whether the user selected the advertisement content displayed on the electronic apparatus 100.

In addition, the information on whether an advertisement service was used may indicate whether the user used a service related to the advertisement content after selecting the advertisement content displayed on the electronic apparatus 100.

Further, the information on the accumulated number of times of display may indicate a value of accumulating the number of times that the advertisement content displayed (or provided) on the electronic apparatus 100 was displayed.

Also, the information on the accumulated number of times of selection may indicate a value of accumulating the number of times that the advertisement content displayed on the electronic apparatus 100 was selected.

In addition, the information on the accumulated number of times of use of the service may indicate a value of accumulating the number of times that a service related to the selected advertisement content was used.

The accumulated number of times of display, the accumulated number of times of selection, and the accumulated number of times of use of the service, etc. may be indicated as accumulation values. As an example, the accumulation values may mean accumulation values for all advertisement contents. As another example, the accumulation values may mean accumulation values for specific advertisement contents.

Also, the information on contribution may include a value indicating how much the user will use the advertisement content. In case the user frequently selects the advertisement content, the contribution score may be relatively high. In contrast, in case the user does not frequently select the advertisement content, the contribution score may be relatively low.

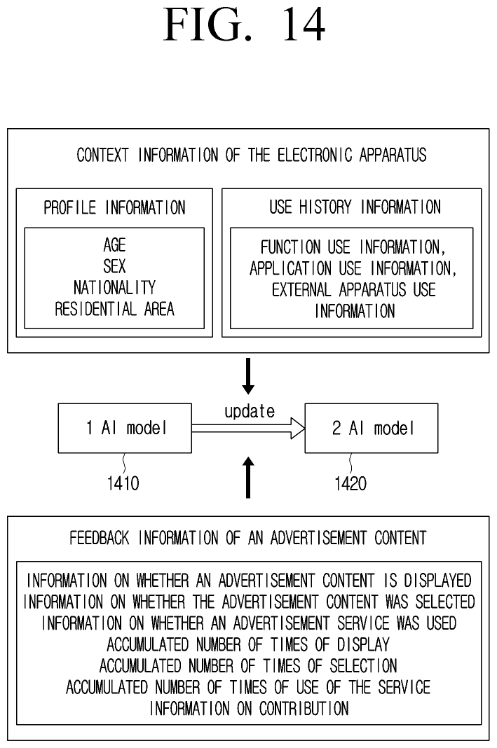

FIG. 14 is a diagram for illustrating a process of updating an artificial intelligence model by using context information and feedback information.

Referring to FIG. 14, the electronic apparatus 100 may update the first artificial intelligence model 1410 to the second artificial intelligence model 1420. Here, the second artificial intelligence model 1420 may be a model that was retrained based on the context information and the feedback information. The electronic apparatus 100 may update the first artificial intelligence model 1410 to the second artificial intelligence model 1420 based on the context information of the electronic apparatus 100 and the feedback information of the advertisement content.

As explanation related to the context information and the feedback information was described in FIG. 12 and FIG. 13, overlapping explanation will be omitted.

FIG. 15 is a flow chart for illustrating an embodiment of providing an advertisement content based on viewing groups in a predetermined number.

The operations S1530, S1535, S1540, S1545, and S1550 in FIG. 15 may correspond to the operations S730, S735, S740, S745, and S750 in FIG. 7. Accordingly, overlapping explanation will be omitted.

The electronic apparatus 100 may obtain a plurality of viewing groups by inputting the context information into the first artificial intelligence model in operation S1505. The electronic apparatus 100 may identify a plurality of viewing groups indicating (or representing) the user. Here, probability values may be determined for each of the plurality of identified viewing groups. The first artificial intelligence model may output the plurality of viewing groups and the probability values corresponding to each of the plurality of identified viewing groups. Here, the probability values may mean values by which the viewing groups can represent the user. The probability values may also be described as viewing group scores. As a probability value is higher, it may mean that the value represents the user better.

Also, the electronic apparatus 100 may identify viewing groups in a predetermined number based on the probability values corresponding to each of the plurality of viewing groups in operation S1506. The electronic apparatus 100 may identify viewing groups in the predetermined number among the plurality of viewing groups. If all of the viewing group information obtained in the operation S1505 is used, it may take a long time to process a transmitting operation and a calculating operation. Accordingly, the electronic apparatus 100 may select viewing groups in the predetermined number. Explanation in this regard will be described in FIG. 20.

Also, the electronic apparatus 100 may transmit the viewing groups in the predetermined number to the server 200 in operation S1510. The server 200 may receive the viewing groups in the predetermined number from the electronic apparatus 100. The server 200 may identify at least one advertisement content based on the viewing groups in the predetermined number in operation S1515.

According to an embodiment, the server 200 may identify an advertisement content based on the viewing groups in the predetermined number.

According to another embodiment, the server 200 may identify two or more advertisement contents based on the viewing groups in the predetermined number.

The server 200 may transmit the identified at least one advertisement content to the electronic apparatus 100 in operation S1520. The electronic apparatus 100 may receive the at least one advertisement content from the server 200. The electronic apparatus 100 may display the received at least one advertisement content in operation S1525. An operation of displaying a plurality of advertisement contents will be described in FIG. 16.

After displaying at least one advertisement content in operation S1525, the electronic apparatus 100 may perform the operations S1530, S1535, S1540, S1545, and S1550.

FIG. 16 is a diagram for illustrating an operation of providing a plurality of advertisement contents.

Referring to FIG. 16, the electronic apparatus 100 may receive a plurality of advertisement contents 1610, 1620, 1630, 1640 from the server 200. The electronic apparatus 100 may provide the plurality of received advertisement contents 1610, 1620, 1630, 1640.

For example, it is assumed that the user is a user who likes soccer. The viewing group information may be determined as a soccer group. If the viewing group information is a soccer group, the advertisement content may be determined as an advertisement related to soccer.

The advertisement content 1610 may be an advertisement of a soccer ball. The advertisement content 1620 may be an advertisement of soccer shoes. The advertisement content 1630 may be an advertisement of a soccer uniform. The advertisement content 1640 may be an advertisement of a soccer cap.

The electronic apparatus 100 may display the plurality of advertisement contents 1610, 1620, 1630, 1640 received from the server 200 on one screen.

FIG. 17 is a flow chart for illustrating an operation of providing advertisement contents based on priorities.

The operations S1705, S1706, S1710, S1730, S1735, S1740, S1745, and S1750 in FIG. 17 may correspond to the operations S1505, S1506, S1510, S1530, S1535, S1540, S1545, and S1550 in FIG. 15. Accordingly, overlapping explanation will be omitted.

The server 200 may identify at least one advertisement content and priority information based on viewing groups in a predetermined number received from the electronic apparatus 100 in operation S1715. The server 200 may identify relative priorities of each of a plurality of advertisement contents. The priority information may indicate which advertisement content will be more appropriate for the user. As the priority is higher, it may mean that the possibility that the user may prefer the advertisement content is higher. The server 200 may transmit the at least one advertisement content and the priority information to the electronic apparatus 100 in operation S1720.

The electronic apparatus 100 may receive the at least one advertisement content and the priority information from the server 200. The electronic apparatus 100 may display the at least one advertisement content based on the priority information in operation S1725. An operation of displaying a plurality of advertisement contents based on the priority information will be described in FIG. 19.

After displaying the at least one advertisement content in operation S1725, the electronic apparatus 100 may perform the operations S1730, S1735, S1740, S1745, and S1750.

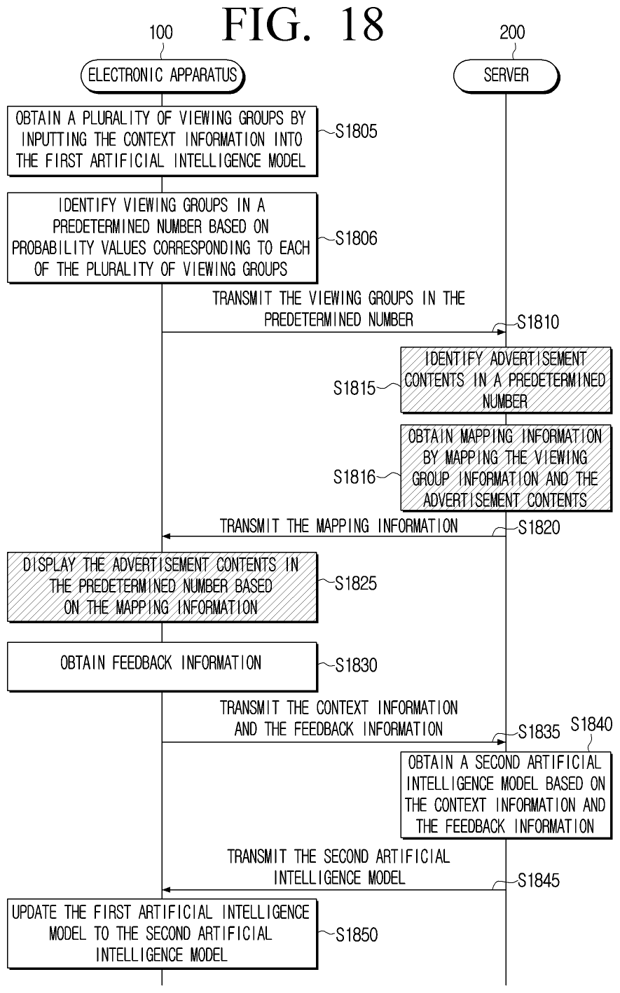

FIG. 18 is a flow chart for illustrating an operation of providing advertisement contents based on probability values.

The operations S1805, S1806, S1810, S1830, S1835, S1840, S1845, and S1850 in FIG. 18 may correspond to the operations S1505, S1506, S1510, S1530, S1535, S1540, S1545, and S1550 in FIG. 15. Accordingly, overlapping explanation will be omitted.

The server 200 may identify advertisement contents in a predetermined number based on the viewing groups in the predetermined number received from the electronic apparatus 100 in operation S1815. Here, the number of pieces of the viewing group information and the number of the advertisement contents may be the same. For example, if four pieces of viewing group information are received, the server 200 may identify four advertisement contents.

Also, the server 200 may obtain mapping information by mapping the viewing group information and the advertisement contents in operation S1816. The server 200 may map the first viewing group information and the first advertisement content, and map the second viewing group information and the second advertisement content. Then, the server 200 may obtain a mapping table wherein the plurality of viewing groups and the plurality of advertisement contents are mapped. The mapping information may include the mapping table. The server 200 may transmit the mapping information to the electronic apparatus 100 in operation S1820.

The electronic apparatus 100 may receive the mapping information from the server 200. The electronic apparatus 100 may display the advertisement contents in the predetermined number based on the mapping information in operation S1825. The mapping information may include the plurality of viewing groups. Here, the viewing group information may include the plurality of viewing groups and probability values corresponding to each of the plurality of viewing groups. Here, the probability values corresponding to each of the viewing groups may be different from one another. The electronic apparatus 100 may display the advertisement contents based on the probability values.

Specifically, the electronic apparatus 100 may determine the sizes of areas wherein the advertisement contents are displayed based on the probability values. The electronic apparatus 100 may display the first advertisement content corresponding to the first probability value in the first area, and display the second advertisement content corresponding to the second probability value smaller than the first probability value in the second area smaller than the first area. Detailed explanation in this regard will be described in FIG. 19.

After displaying the advertisement contents in the predetermined number in operation S1825, the electronic apparatus 100 may perform the operations S1830, S1835, S1840, S1845, and S1850.

FIG. 19 is a diagram for illustrating an operation of providing a plurality of advertisement contents in different styles.

Referring to FIG. 19, the electronic apparatus 100 may receive a plurality of advertisement contents 1910, 1920, 1930, 1940 from the server 200. The electronic apparatus 100 may provide the plurality of received advertisement contents 1910, 1920, 1930, 1940.

For example, it is assumed that the first viewing group information is a soccer group, the second viewing group information is a baseball group, the third viewing group information is a basketball group, and the fourth viewing group information is a tennis group.

Here, it is assumed that the first advertisement content 1910 corresponding to the soccer group is an advertisement of a soccer ball. It is assumed that the second advertisement content 1920 corresponding to the baseball group is an advertisement of a baseball. It is assumed that the third advertisement content 1930 corresponding to the basketball group is an advertisement of a basketball. It is assumed that the fourth advertisement content 1940 corresponding to the tennis group is an advertisement of a tennis ball.

Here, it is assumed that the first probability value included in the first viewing group information is 90, the second probability value included in the second viewing group information is 85, the third probability value included in the third viewing group information is 85, and the fourth probability value included in the fourth viewing group information is 85.

The electronic apparatus 100 may display the first advertisement content 1910 in a size corresponding to the first probability value. The electronic apparatus 100 may display the second advertisement content 1920 in a size corresponding to the second probability value. Here, as the third probability value and the fourth probability value are the same as the second probability value, the sizes of the areas wherein the second advertisement content 1920, the third advertisement content 1930, and the fourth advertisement content 1940 are displayed may be the same. However, as the first probability value is bigger than the second probability value, the size of the area wherein the first advertisement content 1910 is displayed may be bigger than the size of the area wherein the second advertisement content 1920 is displayed.

FIG. 20 is a diagram for illustrating viewing group information.

Referring to the table 2010 in FIG. 20, the viewing group information may include viewing group categories or probability values. Here, the probability values may also be described as viewing group scores.

The viewing group categories may be divided into a plurality of depths. Here, the plurality of depths may include a first depth and a second depth indicating a subordinate concept of the first depth. The sports category of the first depth may include the soccer, the baseball, and the basketball of the second depth. The movie category of the first depth may include the sports, the action, and the drama of the second depth. As a result, viewing groups may be divided according to the second group.

As a result, the viewing group information may include viewing groups divided in the first depth and the second depth. Also, the viewing group information may include probability values corresponding to the viewing groups. Here, the feature that a probability value is high may mean that the viewing group has a high possibility of being a group representing the user.

Meanwhile, the electronic apparatus 100 may identify only viewing groups in a predetermined number among the plurality of viewing groups. This is because the data processing speed may become slower in case all of the pieces of viewing group information in a large number are used.

Meanwhile, the electronic apparatus 100 may identify viewing group information of which probability is greater than or equal to a threshold value. This is because the reliability of output data may be low if the probability value is low.

It is assumed that the threshold value for the probability values is 80, and the predetermined number is 2. The electronic apparatus 100 may identify the pieces of viewing group information (the item 1, the item 2, the item 3) of which probability values are greater than or equal to 80 among the six pieces of viewing group information included in the table 2010. Then, the electronic apparatus 100 may ultimately identify two pieces of viewing group information (the item 1, the item 2) of which probability values are the highest among the identified three pieces of viewing group information. The table 2020 indicates the ultimately identified pieces of viewing group information.

FIG. 21 is a flow chart for illustrating an operation of updating an artificial intelligence model based on context information, label information, and feedback information.

The operations S2115, S2120, S2125, S2130, S2135, S2145, and S2150 in FIG. 21 may correspond to the operations S715, S720, S725, S730, S735, S745, and S750 in FIG. 7. Accordingly, overlapping explanation will be omitted.

The electronic apparatus 100 may obtain viewing group information by inputting at least one of the context information or the label information into the first artificial intelligence model in operation S2105. Then, the electronic apparatus 100 may transmit the viewing group information including the label information in operation S2115.

The server 200 may identify an advertisement content based on the viewing group information including the label information in operation S2120.

Meanwhile, after the operations S2125, S2130, and S2135, the server 200 may obtain a second artificial intelligence model based on at least one of the context information, the label information, or the feedback information in operation S2140. The server 200 may transmit the obtained second artificial intelligence model to the electronic apparatus 100 by using the label information in operation S2145. The server 200 update the first artificial intelligence model to the second artificial intelligence model S2150. Detailed explanation related to the label information will be described in FIG. 22.

FIG. 22 is a table for illustrating context information and label information.

The table 2210 in FIG. 22 includes label information. The label information may mean representative data determined based on context information. At least one label information may be included for each user or each device. The label information may mean information wherein the context information was specified to any one group among a plurality of pre-stored groups.

For example, if the age included in the context information is 35, the electronic apparatus 100 may determine the label information as thirties. If the sex included in the context information is male, the label information may also be male. If the nationality included in the context information is Korea, the electronic apparatus 100 may determine the label information as Asia. If the residential area included in the context information is Seoul, the electronic apparatus 100 may determine the label information as a city of which population is 10 million or more.

Meanwhile, the electronic apparatus 100 may determine the label information as ‘weekday afternoon/news’ by analyzing the function use information included in the context information. The electronic apparatus 100 may determine the label information as ‘weekend afternoon/sports’ by analyzing the application use information included in the context information. The electronic apparatus 100 may determine the label information as ‘weekend morning/game’ by analyzing the external apparatus use information included in the context information.

The electronic apparatus 100 may obtain the viewing group information based on at least one of the context information or the label information.

According to an embodiment, the electronic apparatus 100 may obtain the viewing group information by using only the label information. According to another embodiment, the electronic apparatus 100 may obtain the viewing group information by using both of the context information and the label information.

Meanwhile, depending on implementation examples, the electronic apparatus 100 may provide an advertisement content to the user by using only the label information without obtaining the viewing group information separately.

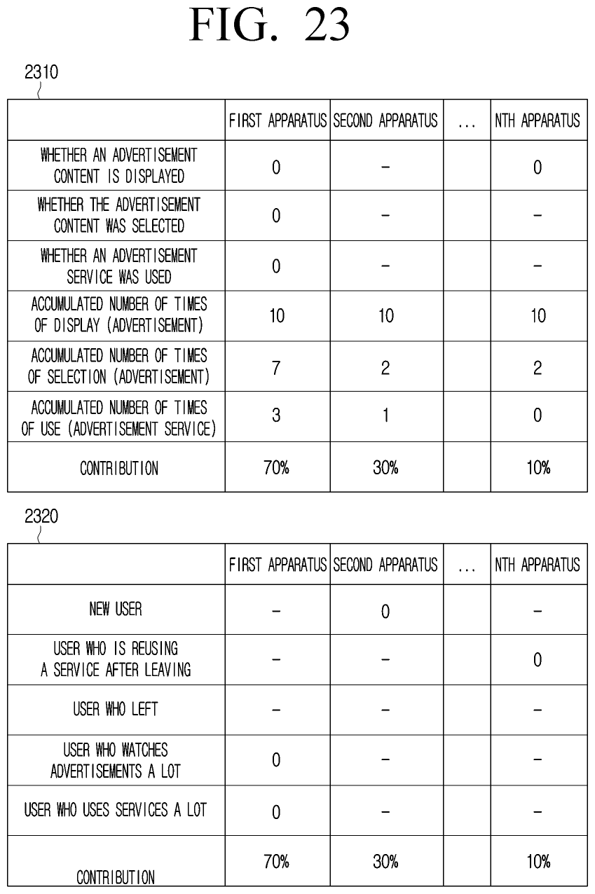

FIG. 23 is a table for illustrating feedback information.

The table 2310 in FIG. 23 indicates feedback information. The feedback information may include at least one of information on whether an advertisement content is displayed, information on whether the advertisement content was selected, information on whether an advertisement service was used, information on the accumulated number of times of display, information on the accumulated number of times of selection, information on the accumulated number of times of use of the service, or information on contribution.

For example, it is assumed that an advertisement is displayed on the first apparatus, and the user selected the advertisement and used a specific service. Also, it is assumed that the user of the first apparatus selected an advertisement seven times among ten times in total, and used a service three times after the seven times of the operation of selecting an advertisement. The electronic apparatus 100 may determine the contribution regarding the user of the first apparatus as 70%. Here, the contribution may also be described as a probability value that the user would use an advertisement content or suitability for an advertisement target, etc.

The table 2320 in FIG. 23 may be additional information included in the feedback information. The feedback information may further include whether the user is a new user, whether the user is a user who is reusing a service after leaving, whether the user is a user who left, whether the user is a user who watches advertisements a lot, whether the user is a user who uses services a lot, etc.

The contribution of a user who watches advertisements a lot or uses services a lot may be relatively bigger. The contribution of a user who left or a user who is reusing the service after leaving may be relatively smaller.

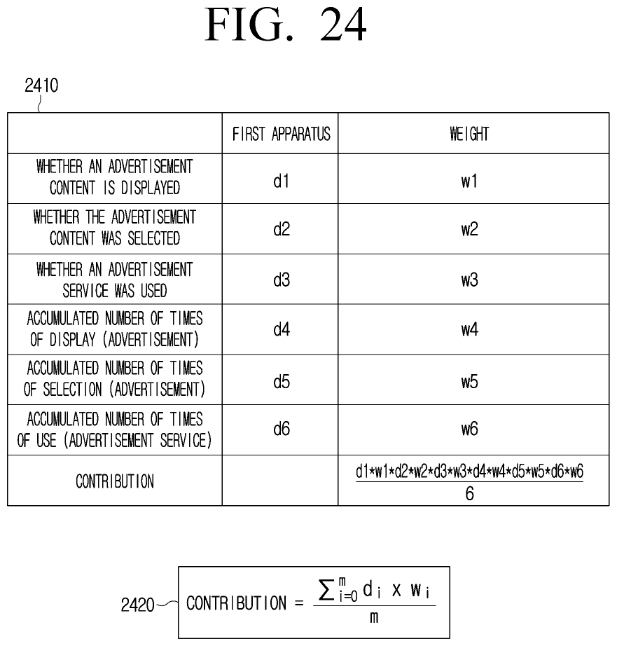

FIG. 24 is a diagram for illustrating a process of calculating contribution.

The table 2410 in FIG. 24 indicates information and weights included in the feedback information. A value regarding whether an advertisement is displayed may be d1, and a weight corresponding to whether an advertisement is displayed may be w1. If an advertisement is displayed, d1 may be 1, and if an advertisement is not displayed, d1 may be 0.

Also, a value regarding whether an advertisement was selected may be d2, and a weight corresponding to whether an advertisement was selected may be w2. If an advertisement was selected, d2 may be 1, and if an advertisement was not selected, d2 may be 0.

In addition, a value regarding whether an advertisement service was used may be d3, and a weight corresponding to whether an advertisement service was used may be w3. If an advertisement service was used, d3 may be 1, and if an advertisement service was not used, d3 may be 0.

Further, a value regarding the accumulated number of times of display (of an advertisement) may be d4, and a weight corresponding to the accumulated number of times of display may be w4. As the accumulated number of times of display is higher, d4 may be bigger.

Also, a value regarding the accumulated number of times of selection (of an advertisement) may be d5, and a weight corresponding to the accumulated number of times of selection may be w5. As the accumulated number of times of selection is higher, d5 may be bigger.

In addition, a value regarding the accumulated number of times of use (of an advertisement service) may be d6, and a weight corresponding to the accumulated number of times of use may be w5. As the accumulated number of times of use is higher, d6 may be bigger.

Meanwhile, the electronic apparatus 100 may calculate contribution based on the data d1-d6 and the weights w1-w6 included in the feedback information.

Meanwhile, the electronic apparatus 100 may calculate contribution based on the formula 2420. In the formula 2420, m may mean the number of pieces of detailed information included in the feedback information. di may mean detailed data included in the feedback information. wi may mean a weight corresponding to each of the pieces of detailed data.

The contribution corresponding to the table 2410 may be (d1*w1+d2*w2+d3*w3+d4*w4+d5*w5+d6*w6)/6.

FIG. 25 is a flow chart for illustrating an operation of providing advertisement contents in different styles according to whether an artificial intelligence model was updated.

The operations S2530, S2535, S2540, S2545, and S2550 in FIG. 25 may correspond to the operations S730, S735. S740, S745, and S750 in FIG. 7. Accordingly, overlapping explanation will be omitted.

The electronic apparatus 100 may obtain first viewing group information by inputting the context information into the first artificial intelligence model in operation S2505. The electronic apparatus 100 may transmit the first viewing group information to the server 200 in operation S2510.

The server 200 may receive the first viewing group information from the electronic apparatus 100. The server 200 may identify a first advertisement content based on the first viewing group information in operation S2515. The server 200 may transmit the first advertisement content to the electronic apparatus 100 in operation S2520.

The electronic apparatus 100 may receive the first advertisement content from the server 200. The electronic apparatus 100 may display the first advertisement content in a first style in operation S2525. The electronic apparatus 100 may obtain feedback information based on the displayed first advertisement content in operation S2530.

After the operations S2535, S2540, S2545, and S2550 are performed, the electronic apparatus 100 may obtain second viewing group information by inputting the context information into the second artificial intelligence model in operation S2555. The electronic apparatus 100 may transmit the second viewing group information to the server 200 in operation S2560.

The server 200 may receive the second viewing group information from the electronic apparatus 100. The server 200 may identify a second advertisement content based on the second viewing group information in operation S2565. The server 200 may transmit the second advertisement content to the electronic apparatus 100 in operation S2570.

The electronic apparatus 100 may receive the second advertisement content from the server 200. The electronic apparatus 100 may display the second advertisement content in a second style in operation S2575.

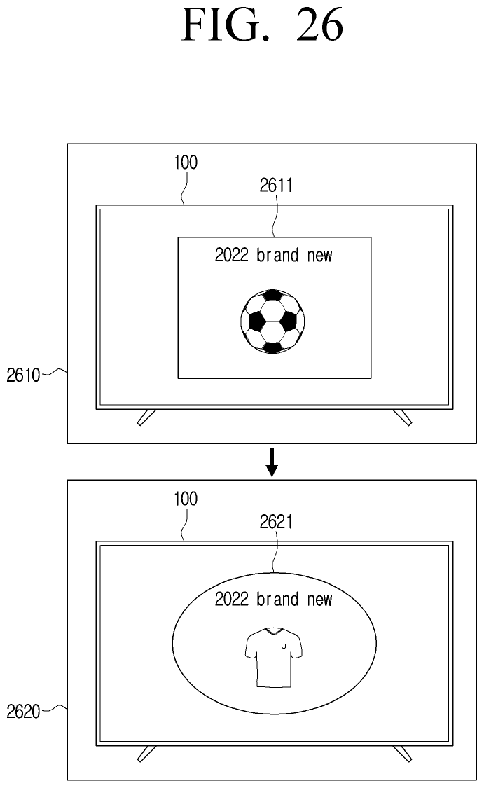

The first style and the second style may be different styles. Detailed explanation in this regard will be described in FIG. 26 and FIG. 27.

FIG. 26 is a diagram for illustrating an operation of displaying a shape of an advertisement content differently.

The embodiment 2610 in FIG. 26 indicates the first advertisement content 2611 provided in the first style. Here, the first style means a method of providing an advertisement content in a quadrangle. The shape of the area wherein the advertisement content is displayed may be a quadrangle.

The embodiment 2620 in FIG. 26 indicates the second advertisement content 2621 provided in the second style. Here, the second style means a method of providing an advertisement content in an oval. The shape of the area wherein the advertisement content is displayed may be an oval.

The electronic apparatus 100 may display advertisement contents in different styles according to artificial intelligence models.

FIG. 27 is a diagram for illustrating an operation of displaying information indicating whether an artificial intelligence model was updated.

The embodiment 2710 in FIG. 27 indicates the first advertisement content 2711 provided to the user. Here, the electronic apparatus 100 may display a screen including the first advertisement content 2711 and text information 2712 indicating the first artificial intelligence model. Here, the first artificial intelligence model may be a model used in obtaining the first advertisement content 2711.

The embodiment 2720 in FIG. 27 indicates the second advertisement content 2721 provided to the user. Here, the electronic apparatus 100 may display a screen including the second advertisement content 2721 and indicators 2722, 2723, 2724 indicating the second artificial intelligence model. Here, the second artificial intelligence model may be a model used in obtaining the second advertisement content 2721. The indicator may include at least one of icon information 2722 indicating whether the artificial intelligence model was updated, version information 2723 of the current artificial intelligence model, or text information 2724 indicating whether the artificial intelligence model was updated.

The electronic apparatus 100 may indicate whether the artificial intelligence model that is currently used was updated together with an advertisement provided to the user. The user can identify the reliability of the artificial intelligence model through the displayed update information.

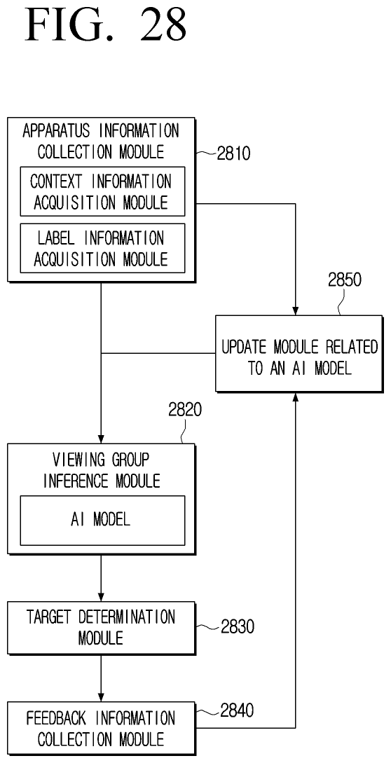

FIG. 28 is a diagram for illustrating an update module related to an artificial intelligence model.

Referring to FIG. 28, for an advertisement content provision system, at least one of an apparatus information collection module 2810, a viewing group inference module 2820, a target apparatus determination module 2830, a feedback information collection module 2840, or an update module 2850 related to an artificial intelligence model may be used. Here, a module may indicate a software or hardware concept.

The apparatus information collection module 2810 may include at least one of a context information acquisition module or a label information acquisition module. The apparatus information collection module 2810 may collect the user's behaviors related to the electronic apparatus 100. For example, the context information may include overall data of a TV such as app session duration/app open count/linear TV viewing/advertisement impression, and click data. Also, the context information may include information on a region wherein the user resides such as subdivision data. The label information may include a user group of a content to be targeted.

The apparatus information collection module 2810 may collect record data that the user used an apparatus (a TV program viewing history/a TV application use history/an external apparatus use history/a viewing history of a TV program genre/a VoD viewing history/a TV game play history/a game genre played/a game publisher, etc.) Also, the apparatus information collection module 2810 may collect viewing data and apparatus usability data, etc. and obtain them as context information for extracting apparatus use characteristics.

The apparatus information collection module 2810 may collect app session/app open data, TV viewing data, external apparatus use dates/time data, advertisement impression and click data, VoD genre data, smart hub use data, game related data, user profile data, subdivision data, etc.

The apparatus information collection module 2810 may collect app session/app open data, TV viewing data, external apparatus use dates/time data, advertisement impression and click data, VoD genre data, smart hub use data, game related data, user profile data, subdivision data, etc.

The apparatus information collection module 2810 may obtain app session/app open data by performing an operation of combining session pieces into one session, and determining values outside a boundary area that may influence the model as missing values and removing the values.

The apparatus information collection module 2810 may obtain VoD genre data by preventing overfitting due to a problem of the curse of dimensionality by mapping Vod program information to a genre.

The viewing group inference module 2820 may infer a viewing group that can represent the user based on at least one of the context information or the label information obtained in the apparatus information collection module 2810. The viewing group inference module 2820 may include an artificial intelligence model. The viewing group inference module 2820 may infer a viewing group that represents a specific apparatus by using the artificial intelligence model.

The target apparatus determination module 2830 may determine whether an apparatus is an apparatus targeted to a specific advertisement based on a viewing group inferred in the viewing group inference module 2820. For example, an advertiser may want to expose an advertisement only to users who would like its advertisement. Accordingly, the target apparatus determination module 2830 may determine to which apparatus among a plurality of apparatuses a specific advertisement should be exposed. The target apparatus determination module 2830 may obtain viewing groups (viewing group information) corresponding to each apparatus from the plurality of apparatuses.

The feedback information collection module 2840 may analyze information related to a user feedback through a provided advertisement content. The feedback information collection module 2840 may generate feedback information based on whether an advertisement content provided to the user was selected and used, etc.

The update module 2850 related to an artificial intelligence model may collect the context information or the label information received from the apparatus information collection module 2810. Also, the update module 2850 may receive the feedback information from the feedback information collection module 2840. The update module 2850 may update the artificial intelligence model used in the viewing group inference module 2820 based on at least one of the context information, the label information, or the feedback information. Then, the update module 2850 may transmit the updated artificial intelligence model to the viewing group inference module 2820.

For the update module 2850, various machine learning methods may be utilized. The update module 2850 may proceed with hyperparameter tuning for each parameter of the model for optimization. The update module 2850 may use incremental learning, online learning, transfer learning, etc. for updating the previous model.

Here, if the weight value of a neural network trained with the previous model is greatly changed, a problem of catastrophic forgetting may occur. That is, as the model is trained to be biased to the latest data characteristics, the precision regarding the past data may be reduced. For resolving this problem, the update module 2850 may perform adjustment such that the learning rate by which the model is trained is maintained to be low, or the model is not trained during update by freezing some neural layers of the neural network. The update module 2850 may maintain and improve the targeting performance by updating the model without the problem of catastrophic forgetting.

Meanwhile, the update module 2850 may change the cycle of updating the model according to the intent. The cycle may be in a unit of one week or one month, or one quarter. The update module 2850 may sequentially update the model in the order of time. In the case of proceeding with update in a unit of one week, the update module 2850 may update the model by utilizing the ads feedback data of the last week of March on April 1. Then, the update module 2850 may update the model that was updated in the previous cycle again by utilizing the ads feedback data of April 1-April 7 on the time point when it becomes April 8. The update module 2850 repeats the updating operation according to the cycle.

Also, the update module 2850 may proceed with n-fold cross-validation or hold-out verification, etc. for verifying the model and improving the generalization performance.

Meanwhile, apparatuses wherein the plurality of modules are operated may be different depending on implementation examples.

According to an embodiment, the apparatus information collection module 2810, the viewing group inference module 2820, and the feedback information collection module 2840 may exist in the electronic apparatus 100, and the target apparatus determination module 2830 and the update module 2850 may exist in the server 200.

According to another embodiment, the apparatus information collection module 2810 and the feedback information collection module 2840 may exist in the electronic apparatus 100, and the viewing group inference module 2820, the target apparatus determination module 2830, and the update module 2850 may exist in the server 200.

According to still another embodiment, the apparatus information collection module 2810, the viewing group inference module 2820, the feedback information collection module 2840, and the update module 2850 may exist in the electronic apparatus 100, and the target apparatus determination module 2830 may exist in the server 200.

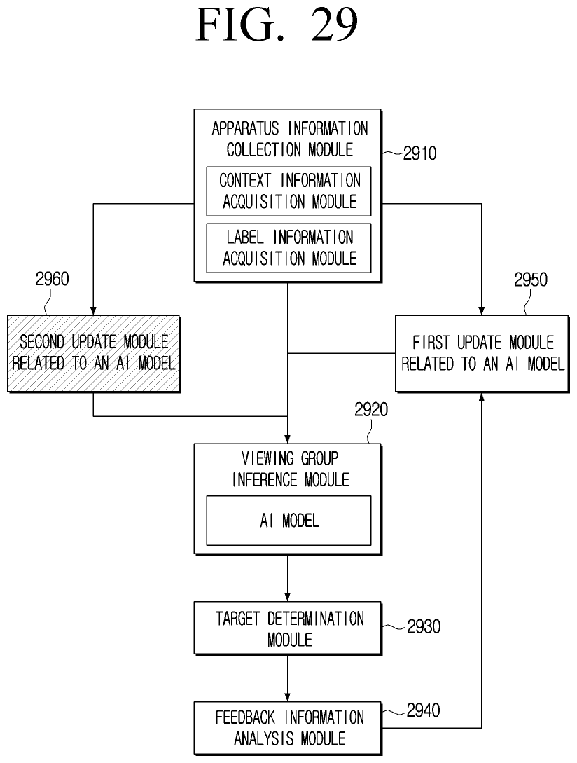

FIG. 29 is a diagram for illustrating a plurality of update modules related to an artificial intelligence model.

Referring to FIG. 29, for an advertisement content provision system, at least one of an apparatus information collection module 2910, a viewing group inference module 2920, a target apparatus determination module 2930, a feedback information collection module 2940, a first update module 2950 related to an artificial intelligence model, or a second update module 2960 related to an artificial intelligence model may be used.

The apparatus information collection module 2910, the viewing group inference module 2920, the target apparatus determination module 2930, and the feedback information collection module 2940 may correspond to the apparatus information collection module 2810, the viewing group inference module 2820, the target apparatus determination module 2830, and the feedback information collection module 2840 in FIG. 28. Also, the first update module 2950 may correspond to the update module 2850 in FIG. 28. Accordingly, overlapping explanation will be omitted.

The advertisement content provision system may additionally include the second update module 2960. The second update module 2960 may receive apparatus information (including at least one of the context information or the label information) from the apparatus information collection module 2910. Also, the second update module 2960 may update the artificial intelligence model used in the viewing group information module 2920 based on the apparatus information. Then, the second update module 2960 may transmit the updated artificial intelligence model to the viewing group inference module 2920.

The updating operation may be performed in each of the two types of modules 2950, 2960.

According to an embodiment, the advertisement content provision system may update the artificial intelligence model based on training data including the feedback information.

According to another embodiment, the advertisement content provision system may update the artificial intelligence model based on training data including only the apparatus information without including the feedback information.

The advertisement content provision system may collect feedback information only during a predetermined period (e.g., a campaign period), and transmit the information to the first update module 2950. Accordingly, the advertisement content provision system may update the artificial intelligence model by using the first update module 2950 in the predetermined period. Also, the advertisement content provision system may update the artificial intelligence model by using the second update module 2960 if it is not the predetermined period.

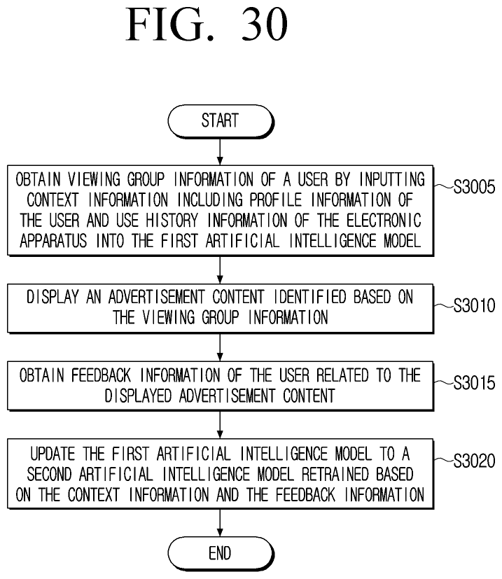

FIG. 30 is a flow chart for illustrating a controlling operation of the electronic apparatus 100 according to an embodiment of the disclosure.

Referring to FIG. 30, a control method for an electronic apparatus storing a trained first artificial intelligence model includes the steps of obtaining viewing group information of a user by inputting context information including profile information of the user and use history information of the electronic apparatus into the first artificial intelligence model (S3005), displaying an advertisement content identified based on the viewing group information (S3010), obtaining feedback information of the user related to the displayed advertisement content (S3015), and updating the first artificial intelligence model to a second artificial intelligence model retrained based on the context information and the feedback information (S3020).

Meanwhile, the profile information may include at least one of the age, the sex, the nationality, or the residential area of the user, and the use history information may include at least one of use information for a function of the electronic apparatus, use information for an application installed in the electronic apparatus, or use information for an external apparatus that communicates with the electronic apparatus.

Meanwhile, the viewing group information may include at least one of a viewing group representing the user or a probability value corresponding to the viewing group representing the user.

Meanwhile, the control method may further include the steps of transmitting the viewing group information to a server configured to communicate with the electronic apparatus, and receiving the advertisement content identified based on the viewing group information from the server, and in the operation S3015 of displaying the advertisement content, the received advertisement content may be displayed.

Meanwhile, the control method may further include the steps of identifying viewing groups in a predetermined number based on probability values corresponding to each of a plurality of viewing groups, and transmitting the viewing groups in the predetermined number to a server configured to communicate with the electronic apparatus, and in the operation S3015 of displaying the advertisement content, based on receiving at least one advertisement content corresponding to the viewing groups in the predetermined number from the server, the at least one advertisement content may be displayed based on probability values corresponding to each of the viewing groups in the predetermined number.

Meanwhile, the feedback information may include at least one of information on whether an advertisement content is displayed, information on whether the advertisement content was selected, information on whether a service corresponding to the advertisement content was used, information on the accumulated number of times of display of the advertisement content, information on the accumulated number of times of selection of the advertisement content, information on the accumulated number of times of use of the service corresponding to the advertisement content, or information on contribution of the advertisement content.

Meanwhile, the control method may further include the step of identifying at least one label information based on the context information, and in the operation S3020 of updating, the first artificial intelligence model may be updated to a second artificial intelligence model retrained based on the context information, the at least one label information, and the feedback information, and the first artificial intelligence model may be a model trained based on a plurality of training context information, a plurality of training label information, and a plurality of training feedback information for a plurality of advertisement contents.

Meanwhile, the control method may further include the steps of transmitting first viewing group information obtained through the first artificial intelligence model to a server configured to communicate with the electronic apparatus, and based on receiving a first advertisement content corresponding to the first viewing group information from the server, displaying the first advertisement content in a first style, transmitting second viewing group information obtained through the second artificial intelligence model to the server, and based on receiving a second advertisement content corresponding to the second viewing group information from the server, displaying the second advertisement content in a second style.

Meanwhile, the control method may further include the steps of obtaining updated viewing group information of the user by inputting the context information into the second artificial intelligence model, and based on obtaining an advertisement content on the basis of the updated viewing group information, displaying the advertisement content and an indicator corresponding to the updated second artificial intelligence model.

Meanwhile, the indicator may include at least one of icon information indicating update, version information of the second artificial intelligence model, or text information indicating update.

Meanwhile, the control method for an electronic apparatus as in FIG. 30 may be executed in an electronic apparatus having the configuration as in FIG. 2 or FIG. 3, and may also be executed in electronic apparatuses having other configurations.

Meanwhile, the methods according to the aforementioned various embodiments of the disclosure may be implemented in forms of applications that can be installed on conventional electronic apparatuses.

Also, the methods according to the aforementioned various embodiment of the disclosure may be implemented just with software upgrade, or hardware upgrade for a conventional electronic apparatus.

In addition, the aforementioned various embodiments of the disclosure may also be performed through an embedded server provided in an electronic apparatus, or an external server of at least one of an electronic apparatus or a display apparatus.

Meanwhile, according to an embodiment of the disclosure, the aforementioned various embodiments of the disclosure may be implemented as software including instructions stored in machine-readable storage media, which can be read by machines (e.g.: computers). The machines refer to apparatuses that call instructions stored in a storage medium, and can operate according to the called instructions, and the apparatuses may include an electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. Also, a storage medium that is readable by machines may be provided in the form of a non-transitory storage medium. Here, the term ‘non-transitory’ only means that a storage medium does not include signals and is tangible, and the term does not distinguish a case wherein data is stored in the storage medium semi-permanently and a case wherein data is stored in the storage medium temporarily.

In addition, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Further, each of the components (e.g.: a module or a program) according to the aforementioned various embodiments may include a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. In addition, operations performed by a module, a program, or other components according to the various embodiments may be executed sequentially, in parallel, repetitively, or heuristically. Or, at least some of the operations may be executed in a different order or omitted, or other operations may be added.

While preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
a display;
a memory storing a trained first artificial intelligence model; and
at least one processor configured to:
obtain viewing group information of a user by inputting context information including profile information of the user and use history information of the electronic apparatus into the first artificial intelligence model;
control the display to display an advertisement content identified based on the obtained viewing group information,
obtain feedback information of the user related to the displayed advertisement content; and
update the trained first artificial intelligence model to a second artificial intelligence model retrained based on the input context information and the obtained feedback information.

2. The electronic apparatus of claim 1,
wherein the profile information comprises:
at least one of age, sex, nationality, and a residential area of the user, and
the use history information comprises:
at least one of use information for a function of the electronic apparatus, use information for an application installed in the electronic apparatus, and use information for an external apparatus that communicates with the electronic apparatus.

3. The electronic apparatus of claim 1,
wherein the obtained viewing group information comprises:
at least one of a viewing group representing the user and a probability value corresponding to the at least one of a viewing group representing the user.

4. The electronic apparatus of claim 1, further comprising:
a communication interface configured to communicate with a server,
wherein the at least one processor is configured to:
transmit the obtained viewing group information to the server through the communication interface,
receive the advertisement content identified based on the obtained viewing group information from the server through the communication interface, and
control the display to display the received advertisement content.

5. The electronic apparatus of claim 1, further comprising:
a communication interface configured to communicate with a server,
wherein the at least one processor is configured to:
identify viewing groups in a predetermined number based on probability values corresponding to each of a plurality of viewing groups;
transmit the identified viewing groups in the predetermined number to the server through the communication interface; and
based on receiving at least one advertisement content corresponding to the identified viewing groups in the predetermined number from the server through the communication interface, control the display to display the at least one advertisement content based on probability values corresponding to each of the identified viewing groups in the predetermined number.

6. The electronic apparatus of claim 1,
wherein the obtained feedback information comprises:
at least one of information on whether an advertisement content is displayed, information on whether the advertisement content was selected, information on whether a service corresponding to the advertisement content was used, information on an accumulated number of times of display of the advertisement content, information on an accumulated number of times of selection of the advertisement content, information on an accumulated number of times of use of the service corresponding to the advertisement content, and information on contribution of the advertisement content.

7. The electronic apparatus of claim 1,
wherein the at least one processor is configured to:
identify at least one label information based on the input context information; and
update the first artificial intelligence model to a second artificial intelligence model retrained based on the input context information, the at least one label information, and the obtained feedback information; and
the first artificial intelligence model being a model trained based on a plurality of training context information, a plurality of training label information, and a plurality of training feedback information for a plurality of advertisement contents.

8. The electronic apparatus of claim 1, further comprising:
a communication interface configured to communicate with a server,
wherein the at least one processor is configured to:
transmit first viewing group information obtained through the first artificial intelligence model to the server through the communication interface;
based on receiving a first advertisement content corresponding to the transmitted first viewing group information from the server through the communication interface, control the display to display the first advertisement content in a first style;
transmit second viewing group information obtained through the second artificial intelligence model to the server through the communication interface; and
based on receiving a second advertisement content corresponding to the second viewing group information from the server through the communication interface, control the display to display the second advertisement content in a second style.

9. The electronic apparatus of claim 1,
wherein the at least one processor is configured to:
obtain updated viewing group information of the user by inputting the context information into the second artificial intelligence model, and
based on obtaining an advertisement content on a basis of the updated viewing group information, control the display to display the advertisement content and an indicator corresponding to the updated second artificial intelligence model.

10. The electronic apparatus of claim 9,
wherein the indicator comprises:
at least one of icon information indicating update information, version information of the second artificial intelligence model, and text information indicating an update.

11. A control method for an electronic apparatus storing a trained first artificial intelligence model, the method comprising:
obtaining viewing group information of a user by inputting context information including profile information of the user and use history information of the electronic apparatus into the first artificial intelligence model;
displaying an advertisement content identified based on the obtained viewing group information;
obtaining feedback information of the user related to the displayed advertisement content; and
updating the first artificial intelligence model to a second artificial intelligence model retrained based on the context information and the obtained feedback information.

12. The control method of claim 11,
wherein the profile information comprises:
at least one of age, sex, nationality, and a residential area of the user; and
the use history information comprises:
at least one of use information for a function of the electronic apparatus, use information for an application installed in the electronic apparatus, and use information for an external apparatus that communicates with the electronic apparatus.

13. The control method of claim 11,
wherein the viewing group information comprises:
at least one of a viewing group representing the user and a probability value corresponding to the at least one of a viewing group representing the user.

14. The control method of claim 11,
wherein the control method further comprises:
transmitting the viewing group information to a server configured to communicate with the electronic apparatus; and
receiving the advertisement content identified based on the transmitted viewing group information from the server, and
the displaying the advertisement content comprises:
displaying the received advertisement content.

15. The control method of claim 11,
wherein the control method further comprises:
identifying viewing groups in a predetermined number based on probability values corresponding to each of a plurality of viewing groups; and
transmitting the identified viewing groups in the predetermined number to a server configured to communicate with the electronic apparatus, and
the displaying the advertisement content comprises:
based on receiving at least one advertisement content corresponding to the viewing groups in the predetermined number from the server, displaying the at least one advertisement content based on probability values corresponding to each of the viewing groups in the predetermined number.

16. The control method of claim 11, wherein the obtained feedback information includes at least one of information on whether an advertisement content is displayed, information on whether the advertisement content was selected, information on whether a service corresponding to the advertisement content was used, information on an accumulated number of times of display of the advertisement content, information on an accumulated number of times of selection of the advertisement content, information on an accumulated number of times of use of the service corresponding to the advertisement content, and information on contribution of the advertisement content.

17. The control method of claim 11, further including identifying at least one label information based on the input context information, and the updating the first artificial intelligence model to a second artificial intelligence model retrained based on the input context information, the at least one label information, and the obtained feedback information, and the first artificial intelligence model is a model trained based on a plurality of training context information, a plurality of training label information, and a plurality of training feedback information for a plurality of advertisement contents.

18. The control method of claim 11, further including:
transmitting first viewing group information obtained through the first artificial intelligence model to a server configured to communicate with a server;
based on receiving a first advertisement content corresponding to the first viewing group information from the server, displaying the first advertisement content in a first styl;
transmitting second viewing group information obtained through the second artificial intelligence model to the server; and
based on receiving a second advertisement content corresponding to the second viewing group information from the server, displaying the second advertisement content in a second style.

19. The control method of claim 11, further including obtaining updated viewing group information of the user by inputting the context information into the second artificial intelligence model, and based on obtaining an advertisement content on a basis of the updated viewing group information, displaying the advertisement content and an indicator corresponding to the updated second artificial intelligence model.

20. The control method of claim 19, wherein the indicator includes at least one of icon information indicating update information, version information of the second artificial intelligence model, and text information indicating an update.
